(19) United States
(12) Patent Application Publication
(10) Pub. No.: US 2024/0010039 A1
(43) Pub. Date: Jan. 11, 2024

(54) BUFFER FOR HYDRAULIC PUMPING DEVICE

(71) Applicant: ClearMotion, Inc., Billerica, MA (US)

(72) Inventors: Brian Alexander Selden, Concord, MA (US); Eric Phares Reeder, Arlington, MA (US); Clive Tucker, Charlestown, MA (US); Mathijs van Staalduinen, Amherst, NH (US); Cameron D. Peterson, Somerville, MA (US); Thomas McVay, Riverside, RI (US); Andrew Kegan Proeschel, Columbus, OH (US)

(73) Assignee: ClearMotion, Inc., Billerica, MA (US)

(21) Appl. No.: 18/023,446

(22) PCT Filed: Aug. 31, 2021
(86) PCT No.: PCT/US2021/048420

§ 371 Date: Feb. 27, 2023

Related U.S. Application Data
(60) Provisional application No. 63/072,470, filed on Aug. 31, 2020.

(51) Int. Cl. B60G 13/08; F15B 1/02

(52) U.S. Cl. CPC B60G 13/08; F15B 1/021; B60G 2202/416; B60G 2202/154

(57) ABSTRACT

Hydraulic systems and methods for reducing the propagation of flow and/or pressure fluctuations within a hydraulic system with a differential buffer are described. A differential buffer may include a first internal volume, a second internal volume, and a barrier separating at least a portion of the first internal volume and at least a portion of the second internal volume. The barrier may move to mitigate pressure and/or flow fluctuations in the first internal volume and the second internal volume by passive destructive interference.

This application claims the benefit of priority under 35 U.S.C. § 119(e) of U.S. Provisional Application Ser. No. 63/072,470, filed Aug. 31, 2020, the disclosure of which is incorporated herein by reference in its entirety.

### FIELD

Disclosed embodiments may be related to methods and systems for the mitigation of pressure fluctuations in hydraulic systems. Some embodiments may be directed to differential buffers for hydraulic pumping devices.

### BACKGROUND

Hydraulic systems, which take advantage of fluids to store, convert, and/or transmit power, are utilized across a variety of industries and applications, from large scale industrial plants to motor vehicles. Such hydraulic systems may generally include a variety of components, such as, for example, hydraulic pumps, valves, various reservoirs or accumulators, tanks, fluid chambers, filters, membranes, other hydraulic components, and the flow passages extending between these components. The flow of hydraulic fluid through and/or between these various components and connections may result in fluid pressure and/or flow fluctuations that may produce vibrations of the components and/or acoustic noise.

### SUMMARY

In some embodiments, a method of operating a hydraulic system that includes a hydraulic device, a hydraulic load, and a differential buffer, includes operating the hydraulic device as a pump to produce an operational differential pressure and a fluctuating differential pressure between a first port and a second port of the hydraulic device, where the fluctuating differential pressure is superimposed on the operational differential pressure. The method also includes applying a total differential pressure across a barrier of the differential buffer exposed to a first fluid volume fluidly connected to the first port and a second fluid volume fluidly connected to the second port, where the total differential pressure is less than or equal to a sum of the operational differential pressure and the fluctuating differential pressure, and displacing at least a portion of the barrier to at least partially mitigate the fluctuating differential pressure that is transmitted to the hydraulic load.

In some embodiments, a differential buffer for a hydraulic system includes a first internal volume, a second internal volume, a first flow passage fluidly connected to the first internal volume, where the first flow passage is configured to fluidly connect to a hydraulic device, and a second flow passage fluidly connected to the second internal volume. The second flow passage is configured to fluidly connect to the hydraulic device, and the first flow passage and the second flow passage are configured to maintain a phase relationship of pressure fluctuations in the first flow passage and the second flow passage. In some embodiments, the inertance and/or the impedance of the first flow passage is effectively equal to the inertance and/or the impedance the second flow passage. The differential buffer also includes at least one barrier separating at least a portion of the first internal volume and at least a portion of the second internal volume, where the barrier is configured to move based on a pressure difference between the first internal volume and the second internal volume, and where the barrier may be biased toward a neutral position.

In some embodiments, a method of operating a differential buffer includes receiving fluid at a first pressure in a first flow passage fluidly connected to a first internal volume of the differential buffer, where the fluid in the first flow passage includes first pressure fluctuations having a first phase, and receiving fluid at a second pressure in a second flow passage fluidly connected to a second internal volume of the differential buffer, where the fluid in the second flow passage includes second pressure fluctuations having a second phase different from the first phase. The method also includes maintaining a phase relationship between the first phase and the second phase from a hydraulic device to the differential buffer, biasing a barrier separating at least a portion of the first internal volume and at least a portion of second internal volume toward a neutral position, and moving the barrier based on a pressure difference between the first pressure and the second pressure.

In some embodiments, a differential buffer for a hydraulic system includes a first internal volume, a second internal volume, a first flow passage fluidly connected to the first internal volume, where the first flow passage has a first inertance, and a second flow passage fluidly connected to the second internal volume, where the second flow passage has a second inertance within 50% of the first inertance. The differential buffer also includes a barrier separating at least a portion of the first internal volume and at least a portion of the second internal volume, where the barrier is configured to move based on a pressure difference between the first internal volume and the second internal volume, and where the barrier may be biased toward a neutral position.

In some embodiments, a method of operating a differential buffer includes receiving fluid at a first pressure in a first flow passage fluidly connected to a first internal volume of the differential buffer, where the first flow passage has a first inertance, and receiving fluid at a second pressure in a second flow passage fluidly connected to a second internal volume of the differential buffer, where the second flow passage has a second inertance within 50% of the first inertance. The method also includes biasing a barrier separating at least a portion of the first internal volume and at least a portion of second internal volume toward a neutral position, and moving the barrier based on a pressure difference between the first pressure and the second pressure.

In some embodiments, a differential buffer for a hydraulic system includes a first internal volume, a second internal volume, and at least one diaphragm separating at least a portion of the first internal volume and at least a portion of the second internal volume, where the at least one diaphragm is configured to deform (e.g. elastically), in at least one operating condition, based on a pressure difference between the first internal volume and the second internal volume.

In some embodiments, a method of operating a differential buffer includes receiving fluid at a first pressure in a first internal volume of the differential buffer, receiving fluid at a second pressure in a second internal volume of the differential buffer, and deforming (e.g. elastically) at least one diaphragm separating at least a portion of the first internal volume and at least a portion of the second internal volume based on a pressure difference between the first pressure and the second pressure.

In some embodiments, a hydraulic system includes a hydraulic device with a first hydraulic device port and a second hydraulic device port, a hydraulic actuator with a first actuator port and a second actuator port, and a differential buffer. The differential includes a first internal volume hydraulically connected to the first hydraulic device port and to the first actuator port, a second internal volume hydraulically connected to the second hydraulic device port and to the second actuator port, and at least one diaphragm separating at least a portion of the first internal volume and at least a portion of the second internal volume, where the at least one diaphragm is configured to deform (e.g. elastically) based on a pressure difference between the first internal volume and the second internal volume.

It should be recognized that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 depicts a graph showing a relationship between the amount of flow volume ripple as a function of the instantaneous state of an exemplary hydraulic device;

FIG. 2 depicts a schematic of one embodiment of a prior art hydraulic circuit including two gas filled accumulators, one on each side of the hydraulic device;

FIG. 3 depicts a schematic of an exemplary embodiment of a hydraulic system with a differential buffer that includes a spring-loaded sliding piston;

FIG. 4 depicts a schematic of another exemplary embodiment of a hydraulic system with a branched differential buffer that includes a spring-loaded sliding piston;

FIG. 5 depicts a schematic an exemplary embodiment of a differential buffer including flexure plates;

FIG. 6 depicts a schematic of an exemplary embodiment of a hydraulic system with a differential buffer that includes flexure plates;

FIG. 7 depicts a graph depicting deflection of an exemplary circular flexure plate according to some embodiments;

FIG. 8 depicts a graph depicting deflection of a second exemplary circular flexure plate according to some embodiments;

FIG. 9 depicts a graph depicting deflection of a third exemplary circular flexure plate according to some embodiments;

FIG. 10 depicts a graph depicting deflection of a fourth exemplary circular flexure plate according to some embodiments;

FIG. 11 depicts a perspective view of one embodiment of a differential buffer;

FIG. 12 depicts an exploded perspective view of the differential buffer of FIG. 11;

FIG. 13 shows a plan view of one embodiment of a spacer ring of the differential buffer of FIG. 11;

FIG. 14 shows a plan view of an embodiment of a second spacer ring of the differential buffer of FIG. 11;

FIG. 15 shows a plan view of one embodiment of a flexure plate of the differential buffer of FIG. 11;

FIG. 16A depicts a first cross-section of the differential buffer of FIG. 11 taken along line 16A-16A;

FIG. 16B depicts a second cross section of the differential buffer of FIG. 11 taken along line 16B-16B;

FIG. 17A depicts a side schematic of one embodiment of a diaphragm and spacers in a first state;

FIG. 17B depicts the diaphragm and spacers of FIG. 17A in a second state;

FIG. 18 is a flow chart for one embodiment of a method of operating a hydraulic circuit;

FIG. 19 is a flow chart for another embodiment of a method of operating a hydraulic circuit; and

FIG. 20 is a flow chart for another embodiment of a method of operating a hydraulic circuit;

FIG. 21 is a flow chart for another embodiment of a method of operating a hydraulic circuit.

### DETAILED DESCRIPTION

In some cases, hydraulic pumps in a hydraulic system, such as positive displacement pumps, may induce flow and/or pressure fluctuations, which may also be referred to as ripple, at both the intake and discharge ports. These fluctuations may be transmitted to various points throughout a hydraulic circuit. The fluctuations may result in the generation of excessive noise, accelerated wear and tear on one or more components of the hydraulic system, and/or reduced system performance in some frequency ranges. The fluctuations may also result in increased noise and/or vibration of the hydraulic system. Compliant reservoirs (e.g., accumulators) are conventionally used to accommodate flow and pressure variations and may partially mitigate the transmission of flow and/or pressure fluctuations to various portions of a hydraulic circuit. However, the inventors have recognized that use of accumulators may result in a need for greater pump capacity in order to establish a desired pressure differential across the pump when accounting for the increased volume. Additionally, as an accumulator is compressed, the compliance of the accumulator may decrease in certain types of accumulators (e.g., the reservoir may become stiffer) and in some cases the compliance may change in a non-linear manner (e.g., in the case of a gas accumulator). Furthermore, accumulators employing a compressible fluid may experience a change in performance based on environmental conditions (e.g., temperature), creating variability in the accumulator's ability to mitigate or cancel fluctuations in a hydraulic system. Accordingly, the inventors have recognized that conventional hydraulic accumulators have certain drawbacks when employed to reduce the effects of pressure or flow fluctuations in a hydraulic system.

In view of the above, the inventors have recognized the benefits of a differential buffer for a hydraulic system configured to mitigate pressure and/or flow fluctuations generated by a hydraulic pump. The differential buffer may employ a phase difference present in flow and/or pressure fluctuations present at locations along different flow passages connected to separate ports of a hydraulic pump to reduce a magnitude of the flow and/or pressure fluctuations that propagate to other portions of a hydraulic system.

Specifically, the differential buffer may be employed to partially or fully cancel fluctuations in pressure differential that may be superimposed on an operational pressure differential between the two internal volumes. In some hydraulic systems, a hydraulic device that may be used as a pump may produce flow ripple at both an intake port and a discharge port. If the hydraulic device is reversible, the same port may alternately act as an intake port or a discharge port. In some embodiments of a hydraulic system, the hydraulic device may produce an operational flow (which may be constant, e.g., zero flow, or variable) at a constant or varying operational pressure differential. The hydraulic device may also produce flow ripple that is superimposed on the operational flow. This ripple may include excess flow or deficit flow relative to the operational flow. In some embodiments, the flow ripple, as a function of time, at one port may be an inverse or mirror image of the flow ripple wave form at the second port. In some embodiments of a hydraulic system, the displacement of at least a portion of one or more barriers in a differential buffer may be used to fully or to partially compensate for flow excess or flow deficit at one or more ports of the hydraulic device. In some embodiments, a differential buffer may be used to passively mitigate, fully or partially, flow ripple excess or flow ripple deficit from reaching the hydraulic device. In some embodiments, this mitigation may be implemented before flow ripple, or the resulting pressure ripple, reach the actuator.

The operational pressure differential may be constant or variable. In some embodiments, the pressure differential between the two internal volumes associated with the flow and/or pressure fluctuations may be used to induce a commensurate change in the instantaneous volume associated with each internal volume to mitigate or eliminate the flow and/or pressure fluctuations. The opposing volume changes of the internal volumes may mitigate the flow and/or pressure fluctuations by destructive interference due to a phase difference between the flow and/or pressure fluctuations in the two internal volumes. Specific embodiments are elaborated on further below including embodiments in which the disclosed differential buffers are used in hydraulic circuits including various types of reservoirs and accumulators as the disclosure is not limited to any specific type of hydraulic circuits that the differential buffers are incorporated into.

In some embodiments, a differential buffer may include a barrier separating at least a portion of a first internal volume and at least a portion of a second internal volume. The barrier may be configured to move to accommodate an increase and/or decrease in pressure and/or flow in the first internal volume and second internal volume. In particular, the barrier may move in response to pressure and/or flow fluctuations. The barrier may be exposed to a pressure of fluid in the first internal volume and the second internal volume. Accordingly, a pressure differential between the first internal volume and second internal volume may cause the barrier to shift position or change shape to accommodate an increase in flow or pressure in the first internal volume and a decrease in flow or pressure in the second flow channel. As discussed above, flow and/or pressure fluctuations may have a shifted or inverse phase between the first channel and second channel, such that the movement of the barrier may mitigate or eliminate the flow and/or pressure fluctuations by destructive interference. Instantaneous changes in pressure and/or flow may be accommodated by a change in volume of the first internal volume and second internal volume based on the movement or changes in the shape of the barrier. In some embodiments, the movement of the barrier may cause an increase in the volume of one of the first internal volume and second internal volume, and a corresponding decrease in the volume of the other of the first internal volume and second internal volume that at least partially mitigates the flow and/or pressure fluctuations in the first and second internal volumes.

According to exemplary embodiments described herein, a differential buffer may include a plurality of barriers disposed between multiple internal volumes. For example, in some embodiments, a plurality of barriers may be disposed between a first internal volume and a second internal volume. The first internal volume may include a plurality of branches, chambers, and/or paths which are separated from corresponding branches, chambers, and/or paths of the second internal volume by the plurality of barriers. In some embodiments, each barrier of a plurality of barriers may be associated with a portion of the first internal volume and corresponding portion of the second internal volume. In some embodiments, a differential buffer may include a plurality of internal volumes, where each pair of internal volumes includes at least one barrier which separates at least a portion of the respective pair of internal volumes.

In some embodiments, a barrier separating the first internal volume and second internal volume may form a flexible wall of the first internal volume and second internal volume that is disposed between the two internal volumes and is capable of being deformed to correspondingly alter the volume of each internal volume as elaborated on below. For example, the barrier may be a diaphragm configured to elastically, or plastically, deform based on the pressure difference between the first internal volume and second internal volume. In such an embodiment, the diaphragm may form at least a portion of a shared wall of the first internal volume and second internal volume. In some embodiments, the diaphragm may be configured as a plate of appropriate cross-section and shape.

In other embodiments, a barrier separating a first internal volume from a second internal volume may be at least one piston movably (e.g., slidably) disposed in one or more corresponding cylinders. In some embodiments, a first side of a piston is exposed to the first internal volume and a second opposing side of the piston is exposed to the second internal volume. According to this embodiment, a piston may move in the cylinder based on a pressure difference between the first internal volume and second internal volume.

While several specific types of barriers are described herein, it should be understood that any suitable barrier configured to move based on a pressure differential between two internal volumes may be employed in the various embodiments disclosed herein as the present disclosure is not so limited. Additionally, any suitable number of barriers of any type may be employed in a differential buffer, as the present disclosure is not so limited.

In some embodiments, the inventors have recognized the benefits of a differential buffer arranged to maintain a desired phase relationship between pressure and/or flow fluctuations in multiple flow passages to facilitate mitigation of such pressure and/or flow fluctuations by destructive interference. That is, the first flow passage and second flow passage, associated with a differential buffer, connected to ports of a hydraulic device (e.g., a hydraulic motor, or a pump) may have symmetry in one or more characteristics of the two flow passages such that pressure and/or flow fluctuations generated at the hydraulic device retain a desired phase relationship at the barrier of the differential buffer. The inventors have recognized that without such symmetry in the differential buffer and/or the associated flow passages between the hydraulic device and the differential buffer, the effectiveness of the differential buffer may be reduced because the desired destructive interference may not be present in the desired frequency ranges. For example, in some cases, phase shift caused by a lack of symmetry in the differential buffer may result in constructive interference of pressure and/or flow fluctuations, increasing the associated negative effects of wear and noise. Accordingly, the inventors have recognized several arrangements which may provide symmetry for a differential buffer, which may be used alone or in any combination. In particular, the inventors have recognized a differential buffer including a barrier which may be biased toward a neutral position, first and second flow passages having equal or effectively equal inertances and/or impedances between various connection points in a hydraulic system, a barrier having equal or effectively equal pressure areas exposed to two associated internal volumes, combinations of the forgoing, and/or other constructions as elaborated on further below.

In some embodiments, a differential buffer includes at least one barrier that may be biased toward a neutral position where an effectively zero pressure differential is applied across the barrier. The biasing of the at least one barrier may allow the barrier to adjust dynamically to an operational pressure difference between fluid in a first internal volume and a second internal volume while responding to fluctuations in the operational pressure difference. As used herein, an “operational pressure difference” or an “operational pressure differential” may refer to a pressure differential generated by a hydraulic device (e.g., a pump) that is employed to operate a hydraulic actuator. The operational pressure difference may either be variable over time or constant depending on the specific application and/or mode of operation. Any flow fluctuations, and pressure fluctuations that may be induced by those flow fluctuations, as described herein may change the operational pressure difference or operational pressure differential. That is, the pressure fluctuations that result from flow fluctuations may be superimposed on the operational pressure difference. In some embodiments, the at least one barrier may be biased to a neutral position by one or more biasing members. For example, in some embodiments, the at least one barrier may be biased to a neutral position by one or more springs. In some such embodiments, the differential buffer may include a single spring engaged with a single side of a barrier configured to bias the barrier toward the neutral position, a first spring engaged with a first side of the barrier and a second spring engaged with a second side of the barrier configured to apply force to the barrier in a direction toward the neutral position, a plurality of first springs engaged with a first side of the barrier and a plurality of second springs engaged with a second side of the barrier, or any other suitable construction. In some embodiments, a differential buffer may include a first set of springs engaged with a first side of a barrier and a second set of springs engaged with a second side of the barrier configured to apply force on the barrier in a direction toward the neutral position. A biasing member may include, but is not limited to, a compression spring, an extension spring, a gas spring, or any other suitable biasing structure. In some embodiments, a barrier may be biased toward a neutral position by material elasticity of the barrier. That is, the barrier may extend across an interface between two internal volumes such that it elastically deforms based on a pressure difference between the internal volumes. The barrier may be biased toward the neutral position by the elastic material properties of the barrier itself. Accordingly, in some embodiments, the barrier may be biased toward a neutral position without the use of any external biasing members.

In some embodiments, a differential buffer may be fluidly connected to a hydraulic device with a first flow passage and a second flow passage which have similar, equivalent, or identical inertances and/or impedances, such that the magnitude and the phase difference of pressure and/or flow fluctuations generated across the hydraulic device are partially or fully replicated across the barrier in the differential buffer. In some embodiments, a first flow passage has a first inertance and/or impedance and a second flow passage has a second inertance and/or impedance. In some embodiments, the inertance and/or impedance of a flow passage may refer to an inertance and/or impedance of an entire flow passage extending between at least one port of the differential buffer and one port of a hydraulic device. In some embodiments, the first inertance and/or impedance may be within 50% of the second inertance and/or impedance. In some embodiments, the first inertance and/or impedance may be within 40%, 30%, 20%, 10%, 5%, or 2% of the second inertance and/or impedance. In some embodiments, the first inertance and/or impedance may be substantially equal or equal to the second inertance and/or impedance. Of course, other suitable relationships of the inertance and/or impedance values for the first flow passage and second flow passage may be employed, as the present disclosure is not so limited.

According to exemplary embodiments described herein, a differential buffer may be configured to mitigate pressure and/or flow fluctuations by, for example, destructive interference. The differential buffer may be configured to maintain a phase difference and, in some embodiments, a magnitude relationship between differential pressure and/or flow fluctuations in two flow passages extending between a hydraulic device and two internal volumes of the differential buffer. As used herein, the term “differential pressure fluctuations” refers to oscillations in differential pressure between points in two flow passages (e.g., at the ports of a hydraulic device) that are superimposed on a steady or varying operational pressure. As used herein, the term “differential flow fluctuations” refers to oscillations in differential flow at points in two flow passages (e.g., at the ports of a hydraulic device) that are superimposed on a steady or varying operational flow.

In some embodiments, the phase difference between the pressure and/or flow fluctuations in two or more internal volumes located on opposing sides of one or more barriers in the differential buffer is equal or approximately equal to 180 degrees (e.g., between 170 and 190 degrees), which may correspond to an inverse phase relationship between the pressure and/or flow fluctuations in the two internal volumes. The phase difference of approximately 180 degrees may allow for a maximum of destructive interference in the differential buffer. The phase difference of approximately 180 degrees may be present in a hydraulic system where an inertance of two flow passages between a hydraulic device (e.g., a pump) and a differential buffer are equal, effectively equal, or substantially equal to one another. In some embodiments, the phase difference between the pressure and/or flow fluctuations in two or more associated internal volumes in the differential buffer is between or equal to 30 degrees and 330 degrees (e.g., 180 degrees±150 degrees), 60 degrees and 300 degrees (e.g., 180 degrees±120 degrees), 90 degrees and 270 degrees (e.g., 180 degrees±90 degrees), between 135 degrees and 225 degrees (e.g., 180 degrees±45 degrees), and between 150 degrees and 210 degrees (e.g., 180 degrees±30 degrees). Phase differences in these ranges may provide for at least some level of destructive interference between the pressure and/or flow fluctuations in the two or more internal volumes. For instance, in some embodiments a phase difference between or equal to 60 degrees and 300 degrees may provide at least a 50% mitigation of the pressure and/or flow ripple and a phase difference between or equal to 90 degrees and 270 degrees may provide at least a 70% mitigation of the pressure and/or flow ripple. In some embodiments, the phase relationship between pressure and/or flow fluctuations on opposing sides of a barrier may be maintained while the total phase difference changes. For example, in some embodiments, the phase of pressure and/or flow fluctuations in either of two internal volumes may be changed by any multiple of 360 degrees (e.g., 360 degrees, 720 degrees, etc.), such that an effective inverse phase relationship is maintained in the two volumes and these variations are intended to be included in the overall noted phase differences. For the purposes of this disclosure, these ranges offset by multiples of 360 degrees should be understood to fall within the above noted ranges. As discussed above, one or more flow passages extending between a hydraulic device and the differential buffer may be configured to maintain a phase relationship between the pressure and/or flow fluctuations produced at the ports of the hydraulic device. Of course, any suitable phase difference and/or phase relationship may be employed in a hydraulic system, as the present disclosure is not so limited.

In some embodiments, a differential buffer includes a barrier having a first pressure area exposed to fluid in a first internal volume, and a second pressure area exposed to fluid in the second internal volume. The first pressure area and second pressure area are deformable areas of the plate, piston, or other structure exposed to pressurized fluid. Depending on the relative size of the first pressure area and the second pressure area, the barrier may move differently under the effect of a pressure differential between the first internal volume and the second internal volume. Accordingly, to effectively cancel pressure and/or flow fluctuations by e.g., destructive interference, the first pressure area and second pressure area may be effectively equal to one another. In some embodiments, the first pressure area may be within 50% of the second pressure area. In some embodiments, the first pressure area may be within 40%, 30%, 20%, 10%, 5%, or 2% of the second pressure area. In some embodiments, the first pressure area may be substantially equal or equal to the second pressure area. Of course, other suitable pressure areas for the barrier may be employed, as the present disclosure is not so limited.

In some embodiments, a method of operating a differential buffer includes receiving fluid at a first pressure in a first flow passage fluidly connected to the differential buffer, where the first flow passage has a first inertance and/or impedance and receiving fluid at a second pressure in a second flow passage fluidly connected to the differential buffer, where the second flow channel has a second inertance and/or impedance within 50%, or other appropriate percentage as noted above, of the first inertance and/or impedance. In some embodiments, the method also includes biasing a barrier separating at least a portion of a first internal volume fluidly connected to the first flow passage and at least a portion of a second internal volume fluidly connected to the second flow passage toward a neutral position. The method also includes moving the barrier based on a operational pressure difference between the first pressure and the second pressure, as well as a pressure difference caused by pressure and/or flow fluctuations. The movement of the barrier may cancel or otherwise mitigate the pressure and/or flow fluctuations in the first internal volume and the second internal volume by destructive interference.

In some embodiments, it may be desirable to reduce leakage from the high pressure portion to the low pressure portion of a hydraulic circuit to promote pump efficiency. Accordingly, the inventors have recognized the benefits of using diaphragm as a barrier, instead of a piston in a cylinder, in a differential buffer for a hydraulic system, where the diaphragm is configured to accommodate pressure fluctuations with little to no leakage across the diaphragm. In some embodiments, a differential buffer may include a first internal volume, and second internal volume, and at least one diaphragm separating at least a portion of the first internal volume from at least a portion of the second internal volume. In some embodiments, the at least one diaphragm may form at least a portion of a common shared wall between the first internal volume and second internal volume. The at least one diaphragm may be configured to move or change shape based on a pressure differential between the first internal volume and the second internal volume. For example, in some embodiments, the at least one diaphragm may be configured to deform (e.g., elastically deform) based on the pressure differential that the at least one diaphragm is exposed to. The deformation of the at least one diaphragm may cause an increase in the volume of the first internal volume while causing a corresponding (e.g., commensurate) decrease in volume in the second internal volume. In this manner, the changes in volume resulting from the deflection of the at least one diaphragm may be used to simultaneously cancel pressure and/or flow fluctuations in the first internal volume and second internal volume. In some embodiments, the at least one diaphragm may be configured cancel or otherwise mitigate the pressure and/or flow fluctuations in the first internal volume and second internal volume by, for example, full or partial destructive interference at the differential buffer.

In some embodiments, a method of operating a differential buffer includes receiving fluid at a first pressure in a first internal volume of the differential buffer, receiving fluid at a second pressure in a second internal volume of the differential buffer, and deforming (e.g., elastically) at least one diaphragm separating at least a portion of the first internal volume and at least a portion of the second internal volume based on a pressure difference between the first pressure and the second pressure. In some embodiments, the deformation or deflection of the at least one diaphragm may partially or fully cancel pressure fluctuations in the first internal volume and the second internal volume by, e.g., destructive interference. In some embodiments, the method may include deforming or deflecting a plurality of diaphragms.

According to exemplary embodiments described herein, a differential buffer may include at least one diaphragm separating at least a portion of a first internal volume and a second internal volume. The inventors have recognized that the size, shape and material properties of a diaphragm affects the response of the diaphragm to various pressure differentials in various applications. For example, a multi-diaphragm buffer may have a larger compliance (e.g., lower stiffness) than a single diaphragm differential buffer where the diaphragms are of the same size, shape and construction. As an alternative example, a multi-diaphragm buffer may have a lesser compliance (e.g., higher stiffness) than a single diaphragm buffer where the multiple diaphragms and single diaphragm have the same total pressure area. Additionally, the inventors have recognized that a diaphragm may have a certain range of elastic deformation prior to the onset of plastic deformation and/or contacting another portion of the differential buffer such that the diaphragm's movement bottoms out. Thus, the inventors have recognized that providing additional diaphragms may allow for a desired stiffness of the differential buffer which may effectively mitigate pressure and/or flow fluctuations without bottoming out the diaphragms, though embodiments in which one or more diaphragms contact an adjacent structure, such as another diaphragm, during normal operation are also contemplated. In some embodiments, the range of diaphragm travel during operation may be selected to avoid contacting adjacent diaphragms. However, embodiments in which one or more diaphragms contact adjacent diaphragms during normal operation are also contemplated. In some embodiments, the at least one diaphragm may include a plurality of diaphragms. In some embodiments, the plurality of diaphragms may include at least 2, 3, 4, 5, 6, 7, 8, 9, 10, 11, or 12 diaphragms. Correspondingly, the plurality of diaphragms may include less than 14, 13, 12, 11, 10, 9, 8, 7, 6, 5, 4, or 3 diaphragms. Ranges of the number of diaphragms are contemplated, including, but not limited to, a number of diaphragms between 2 and 12, 6 and 12, 8 and 12, 2 and 6, and/or any other appropriate range. Of course, any suitable number of diaphragms may be employed, including a single diaphragm, as the present disclosure is not so limited.

According to exemplary embodiments described herein, a diaphragm of a differential buffer may be configured to elastically deform in normal operation based on a pressure difference between a first internal volume and a second internal volume. It should be understood that in some embodiments, an initial amount of plastic deformation may occur either when conditioning the buffer and/or during initial operation of the system. However, after this initial conditioning of the system, in some embodiments, further deformation of the diaphragm may be substantially elastic recoverable deformation. In some embodiments, a diaphragm may be positioned and supported within a differential buffer with at least one spacer disposed on one side of the diaphragm. In some instances, two spacers disposed on either side of the diaphragm such that the diaphragm is disposed between the spacers to secure the diaphragm therebetween. That is, two spacers may clamp the diaphragm to secure the position of the diaphragm between the two spacers. In either case, the at least one spacer may be configured to rigidly secure a periphery, circumference, or other edge of the diaphragm such that the portion of the diaphragm disposed radially inward from the spacer may deform or deflect in response to the operational differential pressure as well as differential pressure fluctuations across the diaphragm. In some embodiments, the at least one spacer may be configured as ring (e.g., having an annular shape) and a corresponding diaphragm may be shaped in the form of a circular disk (e.g., cylindrical) or otherwise shaped as a flat plate. In such an embodiment, the deflected portion of the diaphragm may assume the shape of a semi-sphere or other curved geometry. In some embodiments, a diaphragm may have a curvature when there is not a differential pressure across the diaphragm. Of course, a diaphragm and/or spacer may have any suitable shape, as the present disclosure is not so limited. In some embodiments, the portions of the surface of a secured diaphragm that is exposed to a differential pressure across the diaphragm may be allowed to deflect while the shape of the secured portions of the diaphragm remain constant. For example, in some embodiments, if the slope of an unstressed diaphragm is zero (e.g., relative to a housing of a differential buffer), the slope at the secured regions of the diaphragm may remain at zero while the remainder of the diaphragm surface deflects when that surface is exposed to a differential pressure (e.g., a clamped edge constraint).

The inventors have also recognized that in certain embodiments one or more differential buffer spacers may be configured to secure a diaphragm while avoiding stress risers during deformation of the diaphragm. In particular, the inventors have recognized the benefits of a spacer that includes a curved edge abutting a diaphragm. The curved edge may curve away from the diaphragm such that no sharp (e.g., angular) so that the diaphragm does not interact with a sharp corner when it deflects during operation. The curved edge may have any suitable radius of curvature, as the present disclosure is not so limited.

In some embodiments, a spacer may form a seal with a diaphragm. In some embodiments, the seal may be a metal-to-metal seal. In some embodiments, the seal may include a projection and groove. In some embodiments, the seal may include a sealing gasket. In other embodiments, the seal may be achieved through an adhesive bonding the plates and spacer together. In other embodiments, the seal and attachment of the plates can be achieved through the use of a brazing or melting and flowing of a filler metal into the spaces between the plates and spacers. Of course, any suitable sealing arrangement may be employed, including elastomeric sealing options, as the present disclosure is not so limited. In some embodiments, a spacer may be secured to a diaphragm with one or more fasteners. For example, in some embodiments, a spacer may be secured to a diaphragm with one or more bolts. Of course, any suitable fastener may be employed, including screws, bolts, rivets, etc., as well as other types of connections including welds may be used as the present disclosure is not so limited

As noted above, a diaphragm of a differential buffer may be configured to deform or deflect based on a pressure differential between two internal volumes. The diaphragm may be formed of a material that exhibit sufficient elasticity to permit the diaphragm to elastically deform over a desired operating range in response to a pressure difference between a first internal volume and a second internal volume. In some embodiments, the diaphragm may be formed as a plate. The plate may be formed of a material such as steel, heat-treated alloy steel, carbon spring steel, stainless steel, aluminum, rubber, bulk metallic glass, plastic, or any other suitable material. In some embodiments, a diaphragm may be formed as a constant thickness circular plate. However, in other embodiments, a diaphragm may have a thickness that is not constant, as the present disclosure is not so limited. In some embodiments, certain characteristics of one or more diaphragms may be selected to determine their response to a design pressure differential in a hydraulic system. These characteristics may include, but are not limited to, elongation limit (e.g., a measure of the deformation that occurs before the diaphragm permanently deforms under an applied load), yield strength (e.g., stress at which additional stress moves into the plastic region of a stress-strain curve), tensile strength (e.g., stress at which the material starts to elongate), hardness (e.g., resistance to localized plastic deformation), Young's modulus, and a fatigue strength (e.g., where damage starts to accumulate with cyclic loading). In some embodiments, an elongation limit of a plate may be between 2% and 7%, 2% and 10%, and/or any other appropriate range. In some embodiments, the elongation limit is measured in terms of a ratio of change in length to original length (i.e., AL/L×100). In some embodiments, a yield strength of a plate may be between 1000 MPa and 1500 MPa. In some embodiments, a tensile strength of a plate may be between 1200 and 2100 MPa or between 1300 and 2100 MPa. In some embodiments, a hardness of a plate may be between 40 and 52 HRC. In some embodiments, a Young's modulus of a plate may be between 200 and 210 GPa. In some embodiments, a fatigue strength may be between 650 and 1050 MPa. Of course, any suitable material characteristics may be employed alone or in any combination that fall inside or outside of these exemplary ranges, as the present disclosure is not so limited. In some embodiments, a diaphragm may have a surface finish and/or may be ball cleaned, shot peened, or subjected to other treatments to increase a fatigue resistance of the diaphragm. Of course, while exemplary ranges are provided above for materials that may be employed in exemplary embodiments described herein, any appropriate materials having any appropriate material properties may be employed, as the present disclosure is not so limited. In some embodiments, material properties from the above ranges may be employed alone or in any combination for a diaphragm material, as the present disclosure is not so limited.

According to exemplary embodiments described herein, a spacer of a differential buffer may be configured to secure a diaphragm that deforms or deflects based on a pressure differential between two internal volumes. The spacer may be configured to retain the diaphragm and resist forces associated with the elastic deformation. In some embodiments, the spacer may be formed of metal such as steel, carbon steel, stainless steel, aluminum, plastic, ceramic or any other suitable material. A spacer may have material characteristics suitable for securing a diaphragm and cyclical loading in a hydraulic system. These characteristics may include, but are not limited to, yield strength (e.g., stress at which additional stress moves into the plastic region of a stress-strain curve), tensile strength (e.g., stress at which the material starts to elongate), and hardness (e.g., resistance to localized plastic deformation). In some embodiments, a yield strength of a spacer may be between 370 and 675 MPa. In some embodiments, a tensile strength of a spacer may be between 440 and 1020 MPa. In some embodiments, a hardness of a spacer may be between 71 HRB and 32 HRC. Of course, any suitable material characteristics may be employed for a spacer alone or in any combination that fall inside or outside of these exemplary ranges, as the present disclosure is not so limited.

In some embodiments, a hydraulic system may be space constrained (e.g., inside of a vehicle), such that it may be beneficial to reduce a size of a differential buffer while retaining the desired characteristics. Accordingly, the inventors have also recognized that the benefits of a differential buffer employing a stacked configuration include a relatively small package compared to a non-stacked differential buffer. In some embodiments, a differential buffer may include a plurality of diaphragms in a stacked configuration. In some embodiments, the plurality of diaphragms may be arranged in parallel along a differential buffer longitudinal axis. In some embodiments, the each of the plurality of diaphragms may separate a portion of a first internal volume and a second internal volume. In some embodiments, a spacer may be disposed between each of the plurality of diaphragms to secure the diaphragms and provide space between each of the plurality of diaphragms. Each pair of diaphragms may define a chamber therebetween which may form part of the first internal volume or second internal volume The flow chambers may alternate between pairs of diaphragms, such that each chamber associated with the first internal volume is adjacent to a flow chamber associated with the second internal volume. Such an arrangement allows diaphragms to be added to a differential buffer as desired to achieve a desired stiffness of the differential buffer so that a particular range of pressure and/or flow fluctuations may be mitigated.

In one exemplary embodiment of a differential buffer having a stacked configuration, the differential buffer may include a first internal volume, a second internal volume, a first diaphragm, and a second diaphragm. The first internal volume may include a first chamber disposed between the first diaphragm and the second diaphragm. The second internal volume may include a second chamber disposed on an opposite side of the first diaphragm from the first chamber. The second internal volume may also include a third chamber disposed on an opposite side of the second diaphragm from the first chamber. Accordingly, in such an embodiment, the differential buffer includes chambers arranged in a stacked sequence of second internal volume, first internal volume, and second internal volume. When the first internal volume is at a higher pressure than the second internal volume, the volume of first chamber may expand as the first diaphragm and second diaphragm are forced to deform toward the second chamber and third chamber by the pressure in the first chamber. Conversely, when the second internal volume is at a higher pressure than the first internal volume, the volume of the first chamber may contract as the first diaphragm and second diaphragm are forced to deform toward one another by the pressure in the second chamber and the third chamber. In some embodiments, the first chamber, second chamber, and third chamber may be formed by a first spacer, second spacer, and third spacer, respectively, securing peripheries of the first diaphragm and second diaphragm. In some embodiments, the structure of alternating internal volume chambers between diaphragms may be repeated in a stacked configuration to provide a differential buffer with a desired stiffness for mitigating a desired range of pressure and/or flow fluctuations. For example, 6-12 diaphragms may be employed with a corresponding 7-13 chambers.

According to exemplary embodiments described herein, a first internal volume and a second internal volume of a differential buffer may be at least partially formed through a spacer and diaphragm (e.g., through one or more channels). Such an arrangement may simplify manufacturing and also provide a compact arrangement for a stacked differential buffer. In some embodiments, a portion of the first internal volume and a portion of the second internal volume may be parallel to a longitudinal axis of a differential buffer. According to such an embodiment, the portion of the first internal volume and portion of the second internal volume may run parallel to a direction in which a diaphragm deforms based on a pressure differential between the internal volumes. In some embodiments, the portion of the first internal volume and the portion of the second internal volume may be formed in the spacer and a periphery of the diaphragm engaged with the spacer. One or more spacers may include one or more openings configured to connect one or more chambers of the internal volume. In this manner the diaphragms and/or spacers may be stamped or otherwise manufactured as flat plates that may be stacked to form a portion of a differential buffer. The first internal volume and second internal volume may be formed by properly aligned adjacent holes, cutouts, or openings formed in the spacers and diaphragms of the differential buffer.

In some embodiments, a differential buffer may include a first internal volume, second internal volume, and a barrier configured as a piston separating at least a portion of the first internal volume and the second internal volume. The differential buffer may also include one or more springs configured to bias the piston toward a neutral position. The inventors have recognized that the spring constants of the one or more springs affects the ability to the differential buffer to respond to pressure differentials and also mitigate pressure and/or flow fluctuations in a hydraulic system. In some embodiments, the spring constants may affect the susceptibility of the springs to fatigue stresses under cyclic loading and the ability of the springs to mitigate smaller pressure and/or flow fluctuations. In some embodiments, a spring constant for the differential buffer may be between 1500 and 3000 N/mm. In some cases, a differential buffer including a diaphragm may have spring rate between 1500 and 3000 N/mm in a direction oriented perpendicular to a surface of the diaphragm exposed to the hydraulic fluid as the diaphragm deforms from a neutral position. Of course, spring constants greater than or less than this range are contemplated, as the present disclosure is not so limited. In some embodiments, a differential buffer may include a plurality of springs that are configured to provide an overall combined spring constant for the differential buffer. In some embodiments, a differential buffer may include a number of springs greater than or equal to 2, 3, 4, 5, 6, 7, 8, 9, or 10. Correspondingly, a differential buffer may include a number of springs less than or equal to 12, 11, 10, 9, 8, 7, 6, 5, 4, 3, or 2. Of course, any suitable number of springs may be employed, as the present disclosure is not so limited. In some embodiments, a first spring may be disposed on a first side of the piston, and a second spring may be disposed on a second opposing side of the piston. In some embodiments, two sets of springs may be disposed on opposing sides of the piston. According to these embodiments, the opposing springs may act in compression or tension only as desired, rather than acting in both tension and compression depending on the position of the piston. In some embodiments, an individual spring in a set of springs may have a spring constant between 3000 and 8000 N/mm. In some embodiments, a spring disposed on a first side of the piston may have a different spring constant that a spring disposed on a second side of the piston. Such an arrangement may bias the piston to a desired neutral position to effectively accommodate pressure and/or flow fluctuations.

According to exemplary embodiments described herein, a differential buffer including a barrier arranged as a piston may include a cylinder allowing a length of travel of the piston between end stops. The length of travel may allow for a range of motion of the piston such that an operational pressure differential between a first internal volume and a second internal volume does not cause the piston to reach either end stop. If the piston is disposed at an end stop due to a given operational pressure differential, more minor changes in pressure differential due to pressure and/or flow fluctuations may not cause the piston to move, thereby inhibiting the ability of the piston to cancel the pressure and/or flow fluctuations. A suitable length of travel may be based at least in part on spring constant and an expected pressure differential in the hydraulic system. In some embodiments, the length of the cylinder may be between 50 mm and 100 mm. Of course, any suitable length of cylinder may be employed, as the present disclosure is not so limited.

According to exemplary embodiments described herein, where a piston is employed as a barrier in a differential buffer, the piston may be susceptible to leakage across the piston based on a pressure differential, the tolerance of the piston in a cylinder, and the seals used. In some cases, some leakage across the piston may be beneficial since it may help to mitigate pressure and/or flow fluctuations between a first internal volume and a second internal volume. For example, volumes of fluid flowing across the piston may reduce the effect of a positive increase in pressure and/or flow caused by a pressure and/or flow fluctuation. However, the inventors have also recognized that such leakage may negatively impact the efficiency of a hydraulic system and may affect a pumping capacity for a hydraulic device. In some embodiment, a piston of a differential buffer may have a leakage within 10% of the leakage of the hydraulic device in the system. In some embodiments, a piston of a differential buffer may have a leakage between 1% and 5% of the hydraulic device leakage. Of course, any suitable leakage for a piston may be employed, as the present disclosure is not so limited.

In some embodiments, a hydraulic system may include a hydraulic device, a hydraulic actuator, and a differential buffer. The hydraulic device may be a pump, a hydraulic motor operated as a pump in at least one mode of operation, or other hydraulic power pack configured to actively pump the fluid in at least some embodiments. For example, in some embodiments, the hydraulic device may be a gerotor pump, gear pump, piston pump, swash plate pump, or another suitable hydraulic pump. The hydraulic device may include a hydraulic first hydraulic device port and a second hydraulic device port. The hydraulic actuator may be a hydraulic motor, servo-valve, hydraulic cylinder, or other hydraulic power pack configured to convert hydraulic pressure from the hydraulic device into force, torque, and/or motion. The hydraulic actuator may include a first actuator port and a second actuator port. The differential buffer may include a first internal volume and a second internal volume. The first hydraulic device port may be hydraulically connected to the first actuator port via the first internal volume, and the second hydraulic device port may be hydraulically connected to the second actuator port via the second internal volume. The differential buffer may also include a barrier (e.g., at least one diaphragm or piston) separating at least a portion of the first internal volume and a portion of the second internal volume. The barrier may be configured to move (e.g., change position relative to a housing) or deflect (e.g., change shape in a given position relative to a housing) in response to an operational pressure differential and/or a pressure fluctuations or ripple between the first internal volume and the second internal volume. The differential buffer may function according to exemplary embodiments described herein to mitigate pressure and/or flow fluctuations generated by the hydraulic device.

According to exemplary embodiments described herein, a differential buffer may be arranged in a flow-through configuration or in a branched configuration. In a flow-through configuration, the differential buffer may include a first port and a second port associated with a first internal volume, and a third port and a fourth portion associated with a second internal volume. The first port and third port of the differential buffer may be fluidly connected to a hydraulic device (e.g., via flow passages), where the second port and fourth port are fluidly connected to a hydraulic actuator (e.g., via flow passages). In this manner, fluid flowing from the hydraulic device to the hydraulic actuator flows through the internal volumes differential buffer. In an alternative embodiment where the differential buffer has a branched configuration, the differential buffer may include a first port associated with a first internal volume, and a second port associated with a second internal volume. The first port may be connected to a first flow passage between a hydraulic device and a hydraulic actuator (e.g., via a first branched connection), and the second port may be connected to a second flow passage between the hydraulic device and the hydraulic actuator (e.g., via a second branched connection). In this embodiment, fluid may flow between the hydraulic device and the hydraulic actuator without flowing through the differential buffer, such that the flow passage to the differential buffer branches off of the first flow passage and second flow passage. In some cases, with a branched configuration the differential buffer branch may block access to the differential buffer from pressure fluctuations above a threshold frequency. Depending on desired packaging and a frequency of pressure and/or flow fluctuations intended to be mitigated, a flow-through or branched configuration may be employed, as the present disclosure is not so limited.

According to exemplary embodiments described herein, a hydraulic system may operate at an operating pressure difference between two internal volumes of a differential buffer. That is, an operational pressure difference (e.g., a pressure difference that does not include pressure fluctuations) may be present in a hydraulic system. In some embodiments, a pressure difference between the first internal volume and second internal volume may be between 0 and 3000 psi (e.g., 0 and 21 MPa). In some embodiments, a pressure difference between the first internal volume and second internal volume may be between 0 and 1000 psi (e.g., 0 and 7 MPa). Pressure fluctuations generated by a hydraulic device are less than an operational pressure difference generated between the first internal volume and the second internal volume. For example, in some embodiments, a fluctuating pressure difference caused by pressure fluctuations may be between 0 and 500 psi (e.g., 0 and 3.5 MPa), between 0 and 1450 psi (e.g., 0 and 10 MPa), and/or any other appropriate pressure range. In some embodiments, a fluctuating pressure difference caused by pressure fluctuations may be between 0.01 and 50 psi (e.g., between 0.00007 and 0.345 MPa). According to these embodiments, the fluctuating pressure differences may be superimposed on an operational pressure difference and may be either positive or negative (e.g., ±0-3.5 MPa, ±0-10 MPa, or ±0.00007-0.345 MPa). The fluctuating pressure differences may be smaller than an operational pressure difference. Accordingly, a differential buffer may be configured to mitigate the pressure fluctuations at lower relative fluctuating pressure differences than an operational pressure difference of a hydraulic system. To this end, a differential buffer may be configured to accommodate an operational pressure differential plus any pressure differential caused by pressure fluctuations without bottoming out. As used herein, “bottoming out” may indicate a position where a barrier of a differential buffer is unable to move in one direction in response to the fluctuating pressure difference (e.g., from contacting another barrier, contacting another portion of the differential buffer, reaching an end of travel, etc.). Of course, any suitable operational pressure difference may be employed, and any desired pressure difference from pressure fluctuations may be mitigated, as the present disclosure is not so limited.

According to exemplary embodiments described herein, pressure fluctuations in a hydraulic system may be at a frequency or a range of frequencies which a differential buffer is configured to mitigate. In some embodiments, a pressure fluctuation may be at a frequency between 0 and 2000 Hz. In some embodiments, a pressure fluctuation may have a frequency between 0 and 400 Hz. Of course, any relevant frequencies of pressure fluctuations generated by a hydraulic device may be mitigated by a differential buffer, as the present disclosure is not so limited. Mitigating of pressure and/or flow fluctuations in a particular frequency range means that pressure and/or flow fluctuations may be mitigated uniformly at every frequency in the frequency range or a subset of the frequency range may be targeted for mitigation, as the present disclosure is not so limited.

In some embodiments of hydraulic actuators (e.g., hydraulic active suspension system actuators), an operating parameter is the bandwidth of the force that may be produced. In some embodiments of high bandwidth hydraulic actuators, a significant portion of the flow from the actuator body may pass through the associated hydraulic device. In some embodiments, the rotational inertia, of one or more rotating hydraulic device components, may limit the bandwidth of the system. In some embodiments, the displacement of the hydraulic device may also determine how much the hydraulic device component may need to rotate for a given flow generated at the actuator. In some embodiments, an internal gear pump may be used with a rotational inertia to displacement ratio within a range of 20-40 kg/m. However, hydraulic devices with rotational inertia to displacement ratios both above and below this range are contemplated, as the disclosure is not so limited.

In some embodiments, hydraulic devices (e.g., gerotor pumps, gear pumps, piston pumps, swash plate pumps, etc.) may produce pressure and/or flow fluctuations even when the hydraulic device is operating at a constant angular speed (e.g. constant operating flow). Such flow may be caused by, for example, variation in: (i) hydraulic device displacement and/or (ii) leakage, as a function of angular position of a component of the hydraulic device. For example, in the case of a gerotor pump, the variation in hydraulic device displacement as a function of angular position, of an inner or outer rotor, may be an inherent characteristic of the hydraulic device and/or due to, for example, manufacturing tolerances or imperfections. Alternatively or in addition, in some embodiments, the variation in leakage in the hydraulic device may be due to the path length between the high and low pressures within the hydraulic device. Such path lengths may vary as a function of the angular position of a component of the hydraulic device.

In some embodiments of hydraulic systems, the flow passages on either side of a hydraulic device remain independent or separate from each other until the hydraulic load (e.g., an actuator or a servo-valve) is activated. Under some operating conditions in some embodiments, both sides of the hydraulic device may produce flow volume ripple which may in turn induce acoustic noise. As used herein, the term “flow passage” or “fluid flow passage” refers to a conduit, channel, tube, passage, passageway, or any other type of flow path for conveying liquid or hydraulic fluid from one point to another in a hydraulic system.

According to exemplary embodiments described herein, a differential buffer may be employed in any hydraulic system that may be susceptible to pressure and/or flow fluctuations. For example, a differential buffer may be employed in hydraulic systems in marine systems (e.g., boats, submarines, etc.), automotive systems (e.g., cars, trucks, ATVs, motorcycles, tractor trailers), construction systems (e.g., excavators, bulldozers, etc.), airborne systems (e.g., planes, helicopters, etc.), suspension systems (e.g., active suspension systems, semi-active suspension systems, etc.) or any other suitable system, as the present disclosure is not so limited.

In the various embodiments described herein, a phase difference of the flow and/or pressure fluctuations described herein may be measured in any appropriate manner. For example, in some instances, the fluctuations may be measured using flow and/or pressure sensors located at the noted locations within the hydraulic system. Alternatively, a fluid dynamics simulation software, such as a computational fluid dynamics analysis tool, may be used to determine the phase relationships and/or magnitudes of the flow and/or pressure fluctuations within the various locations of the hydraulic system.

According to exemplary embodiments described herein an inertance and/or impedance of a flow passage in a hydraulic system may be measured via computational fluid dynamics simulations of the hydraulic system. In some embodiments, such a computational simulation may be employed to determine if a desired phase relationship between pressure and/or flow fluctuations in a hydraulic system is maintained as desired to allow the pressure and/or flow fluctuations to be attenuated. In some embodiments, a matching inertance and/or impedance calculated from a computational fluid dynamics simulation may be indicative of a hydraulic system configured to maintain a desired phase relationship and/or phase difference of flow ripple between two sides of the hydraulic system. Of course, any suitable inertance for a fluid passage, e.g., 1×10⁶ MPa/(m³/s²) to 1×10 7 MPa/(m³/s²), or 3×10 6 MPa/(m³/s²), in a hydraulic system may be employed as the present disclosure is not so limited. Additionally, inertance and/or impedance of a fluid passage may be determined in any empirical and/or computational method appropriate manner, as the present disclosure is not so limited. Additionally, the occurrence of a desired phase relationship as disclosed herein between two fluid volumes located on opposing sides of a barrier of a differential buffer may be indicative of the inertances and/or impedances of the flow paths connecting the differential buffer to a hydraulic device having a desired matched relationship, e.g. effective equivalence, to provide the desired pressure and/or flow ripple mitigation as described herein.

According to exemplary embodiments described herein, “canceling”, “mitigation”, or “attenuation” is what occurs when pressure and/or flow fluctuations on two sides of a barrier of a differential buffer of a hydraulic system maintain a desired phase relationship such that a magnitude and/or effect of volume fluctuations between the two portions of the hydraulic system (e.g. separate flow paths connected to the two opposing ports of a hydraulic device) may be reduced, or effectively eliminated. Specifically, movement of the barrier induced by the pressure and/or flow ripple may at least partially compensate for these pressure and/or flow fluctuations in the separate portions of the hydraulic system to reduce a magnitude and/or effect of the corresponding volume fluctuations in the different portions of the hydraulic system, e.g., at a load. Thus, a differential buffer according to exemplary embodiments described herein may diminish the negative affects associated with pressure and/or flow ripple, as described above.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

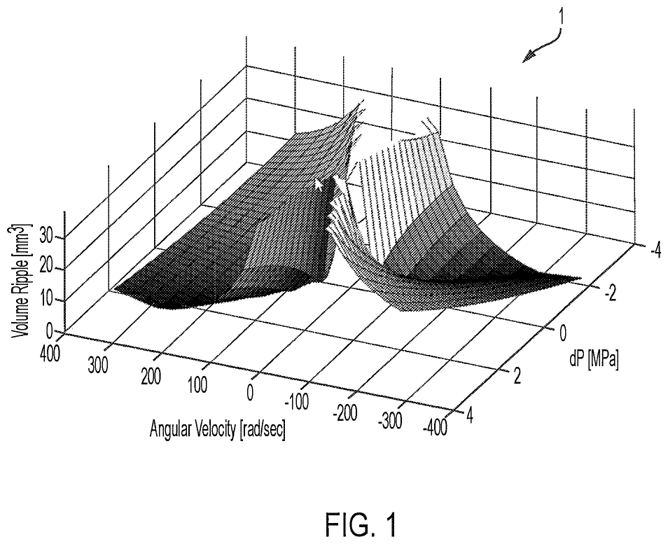

FIG. 1 depicts a graph showing a relationship between the amount of flow volume ripple as a function of the instantaneous state of an exemplary hydraulic device. In some embodiments, even when a hydraulic device is operating at a constant angular speed, the instantaneous volume flow into and from the hydraulic device may fluctuate. These fluctuations may be referred to as flow volume ripple. Under certain conditions, for example, when the angular speed of the hydraulic device is intentionally varied, in order to, for example, vary the flow at a given first frequency, higher frequency flow volume ripple may be super imposed on the operational flow. Flow volume ripple may be due to an instantaneous excess of fluid flow volume on one side of the hydraulic device and a corresponding instantaneous deficit of fluid flow volume on the opposite side. The amount of flow volume ripple may depend on the instantaneous state of the hydraulic device, as shown in FIG. 1. In a closed or open hydraulic system, hydraulic flow volume ripple produced by a hydraulic device may be converted into high frequency pressure fluctuations (e.g., pressure ripple) that may be superimposed on the operational pressure (whether the operational pressure is constant or variable) on either or both sides of the hydraulic device. The production of pressure ripple may result in the production of objectional levels of acoustic noise and/or other objectional effects, such as, accelerated wear and tear on various components. In some embodiments, the operational rotational speed of the hydraulic device may vary from 0 to 100 Hz or from 0 to 400 Hz. However, operational rotational speeds above these ranges are considered, as the present disclosure is not so limited. In some embodiments, the flow volume ripple frequency and/or the pressure ripple frequency may be 5 to 10 times greater than the operational frequency of the hydraulic device. In some embodiments, the flow volume ripple frequency and/or the pressure ripple frequency may be 10 to 20 times greater than the operational frequency of the hydraulic device. However, pressure ripple frequencies both above and below the indicated ranges are contemplated, as the disclosure is not so limited.

In view of the above description, and given the relationship between these terms, flow ripple and pressure ripple may be related and may be used interchangeably in the current disclosure.

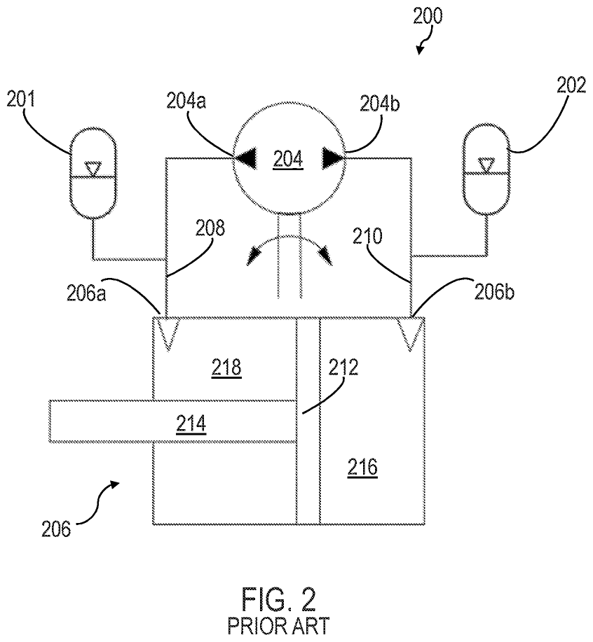

FIG. 2 depicts a schematic of one embodiment of a prior art hydraulic circuit 200 that includes a first gas filled accumulator 201 and a second gas filled accumulator 202. The first accumulator 201 is fluidically connected to a first hydraulic device port 204a of a hydraulic device 204 and to a first actuator port 206a of a hydraulic actuator 206 by a first flow passage 208. The second accumulator 202 is fluidically connected to a second hydraulic device port 204b of the hydraulic device 204 and to a second actuator port 206b of the actuator 206 by a second flow passage 210. Each of the first accumulator 201 and second accumulator 202 may provide absolute compliance to the hydraulic circuit and may, at least partially, mitigate the flow volume ripple produced by the hydraulic device, and reduce the production of pressure ripple that may reach the actuator 206. As used herein, the term “absolute compliance” refers to a branched or flow-through compliance device that acts on a hydraulic circuit at one location. As shown in FIG. 2, the hydraulic actuator includes a piston 212 slidably received in a cylindrical volume in actuator 206. The piston 212 is coupled to a rod 214 that may be used to apply a force. The piston 212 also separates an internal volume in the actuator into a first volume, the compression volume 216, and a second volume, the extension volume 218. The compression volume is a volume that is compressed when the actuator undergoes compression while the extension volume is a volume that is compressed when the actuator undergoes extension.

In the embodiment illustrated in FIG. 2, the gas filled volume in the first gas filled accumulator 201 and the second gas filled accumulator 202 may each act as a gas spring which determines the compliance of each of the respective sides of the hydraulic circuit 200. Without such accumulators, the flow volume ripple may act on a volume filled hydraulic oil or other liquid that may have a much higher bulk modulus than a gas. Such interaction with a liquid filled circuit may create greater pressure ripple than a system with compliance. However, in a two-accumulator configuration as shown in FIG. 2, noise performance of the hydraulic circuit may be tied to the performance of one or both of the first accumulator 201 and the second accumulator 202. If the first and second accumulators do not function properly, the noise performance of the entire hydraulic circuit may degrade as both sides of the hydraulic circuit are connected at the load (e.g., the hydraulic actuator 206). Further, in some embodiments as discussed above, using a gas medium in an accumulator may result in undesirable behavior. For example, the stiffnesses of one or both accumulators may be a non-linear function of temperature, which may change with operation of the system or environmental conditions.

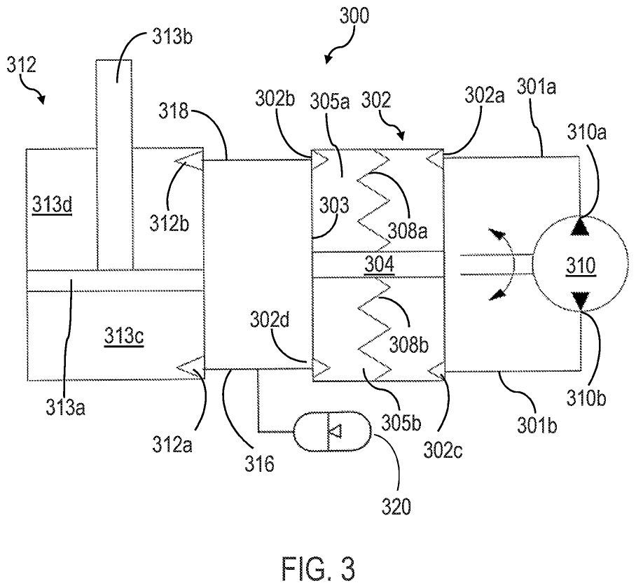

FIG. 3 depicts a schematic of an exemplary embodiment of a hydraulic system 300 with a differential buffer 302 configured to mitigate pressure and/or flow fluctuations. In some embodiments, as shown in FIG. 3, the differential buffer 302 includes a moving piston 304 slidably received in a cylinder 303 in a housing of the differential buffer 302. The differential buffer also includes a first spring 308a and a second spring 308b associated with opposing sides of the piston and interposed between the piston 304 and the housing of the differential buffer 302. The springs are arranged to bias the piston in opposite directions along the longitudinal axis of cylinder 303. That is, the first spring and second spring collaborate to bias the piston 304 toward a neutral position. In the embodiment of FIG. 3, the differential buffer 302 is operatively interposed between a hydraulic device 310 and a hydraulic actuator 312. The hydraulic actuator 312 of FIG. 3 includes a piston 313a, piston rod 313b, compression volume 313c, and extension volume 313d. The compression volume is compressed when the actuator 312 is compressed, while the extension volume is compressed when the actuator 312 is extended. In some embodiments, the hydraulic actuator may be replaced by another hydraulic load as the present disclosure is not limited in this respect.

In the embodiment of FIG. 3, the differential buffer 302 is configured as a flow-through-differential buffer. The differential buffer includes four ports (e.g., first port 302a, second port 302b, third port 302c, and fourth port 302d) two of which may be inlet ports at any given time while the other two ports may be outlet ports. The first port 302a and the second port 302b are associated with a first internal volume 305a of the differential buffer on a first side of the piston 304. The third port 302c and the fourth port 302d are associated with a second internal volume 305b of the differential buffer on a second side of the piston 304 opposing the first side. In the flow-through configuration shown in FIG. 3, the entire flow, or effectively the entire flow, to and from the hydraulic device 310 may flow through the first internal volume and the second internal volume of the differential buffer 302. In the hydraulic system 300, fluid flow passage 316 fluidically connects the fourth port 302d of the differential buffer to a first actuator port 312a of the actuator 312, while fluid flow passage 318 hydraulically connects the second port 302b of the differential buffer to a second actuator port 312b of the actuator 312. The first port 302a is fluidically connected to a first hydraulic device port 310a via fluid flow passage 301a. The third port 302c is fluidically connected to a second hydraulic device port 310b via fluid flow passage 301b. In some embodiments as shown in FIG. 3, the hydraulic system 300 may include a pressurized accumulator 320 (e.g., a gas filled accumulator) which may be fluidically connected to the fluid flow passage 316 or another suitable fluid flow passage. For example, a pressurized accumulator 320 (e.g., a gas filled accumulator) may be hydraulically connected to the fluid flow passage 318. Alternatively or additionally, a pressurized accumulator (e.g., a gas filled accumulator) may be hydraulically connected to the fluid flow passage 318. In the embodiment of FIG. 3, pressure or flow ripple has been fully or partially mitigated in the fluid flowing through fluid flow passage 316 or fluid flow passage 318, towards ports 312a and 312b, respectively, by the differential buffer 302.

According to the embodiment of FIG. 3, the various flow passages on opposing sides of the hydraulic system 300 may have similar (e.g., equivalent) inertances and/or impedances. In some embodiments, the inertance and/or impedance of the first internal volume 305a is within 50% of the inertance and/or impedance of the second internal volume 305b, and, in some embodiments, the inertance and/or impedance of the first internal volume 305a is equal to the inertance and/or impedance of the second internal volume 305b. In some embodiments, an inertance and/or impedance of the flow passage 301a between the first port 302a and the first hydraulic device port 310a and an inertance and/or impedance of the flow passage 301b between the third port 302c and the second hydraulic device port 310b are within 50% of one another, and in some embodiments are equal to one another. For example, the first and second flow passages connecting the first hydraulic device port 310a and second hydraulic device port 310b of the hydraulic device 310 to the corresponding first port 302a and third port 302c of the buffer may have matched inertances and/or impedances within a predetermined range of each other (e.g., within 50%), as described above, to provide a desired phase relationship of pressure and/or flow fluctuations propagating to or from the hydraulic device. In some embodiments, the inertances and/or impedances of the flow passage 301a and the flow passage 301b may not be within 50% with one another, but may maintain a desired phase relationship (e.g., an inverse phase relationship) between pressure and/or flow fluctuations between the hydraulic device 310 of the differential buffer 302. In some embodiments, the fluid flow passage 316 and fluid flow passage 318 have equivalent or similar inertances and/or impedances (e.g., the inertance and/or impedance of the fluid flow passage 316 may be within 50% of the inertance and/or impedance of the fluid flow passage 318), though such an arrangement may not affect the mitigation of pressure and/or flow fluctuations by the differential buffer,

In some modes of operation, the differential buffer 302 may be exposed to constant and/or variable operational differential pressures produced by the hydraulic device 310 when driving the hydraulic actuator 312 (e.g., in an active suspension system). Such a differential buffer may also simultaneously absorb or mitigate flow volume ripple on one or both sides of a hydraulic device, while providing an appropriate degree of compliance on one or both sides of the hydraulic device. In some embodiments, a differential buffer like that of FIG. 3 may be exposed to differential pressures in the range of 300 to 600 psi (e.g., 2.1 to 4.1 MPa) while mitigating volume ripple that may produce pressure ripple in the range of 0.1 to 10 psi (e.g., 0.0007 to 0.0689 MPa). Of course, other ranges of pressures are contemplated, as the present disclosure is not so limited.

In some embodiments, a differential buffer according to exemplary embodiments herein may be exposed to operational differential pressures in the range of 0 psi to 1000 psi (e.g., 0 to 7 MPa), or one or more sub-ranges of this range of operational differential pressure, as the disclosure is not so limited. In some embodiments, a differential buffer according to exemplary embodiments herein may be configured to mitigate (e.g., damp) pressure ripple in the range of 0.01 to 50 psi (e.g., between 0.00007 and 0.345 MPa) or one or more sub-ranges of this range of pressure ripple, as the disclosure is not so limited. Various combinations of the above ranges are contemplated including, for example, operational pressure ranges between or equal to about 100 psi to 600 psi (e.g., 0.69 to 4.1 MPa) and pressure ripple in the range of 0.1 to 20 psi (e.g., 0.0007 to 0.138 MPa), and/or any other appropriate combination of ranges, as the disclosure is not so limited. Mitigating of pressure ripple or flow ripple in a particular pressure range does not necessarily indicate that pressure ripple is mitigated uniformly throughout that range or even at each pressure in that range.

In one example of the differential buffer 302 illustrated in FIG. 3, the piston 304 may include a 60 mm diameter and may be exposed to 7800 N of force while functioning to absorb ripple pressure that may only produce 60 N of force. In some embodiments, leakage past the piston 304 may adversely affect the efficiency of the hydraulic device 310 as discussed above. This is because a hydraulic device may have to pump more fluid volume to make up for such leakage. However, inventors have recognized that a seal between the piston 304 and cylinder 303 may be employed to withstand higher levels of differential pressures with less leakage. However, such seals may, in some cases, significantly increase levels of seal friction. The inventors have recognized that these frictional forces may degrade the effectiveness of the differential buffer to absorb low amplitude but high frequency flow ripple. Accordingly, in some embodiments, a seal may be employed between the piston 304 and the cylinder 303, whereas in other embodiments, no seal may be employed between the piston and the cylinder, as the present disclosure is not so limited.

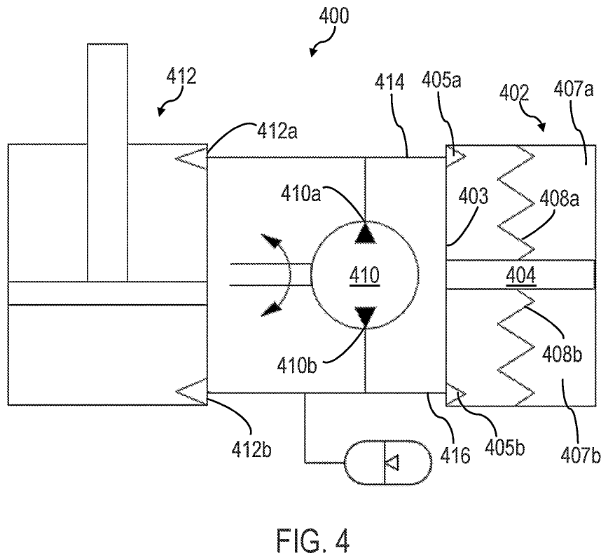

FIG. 4 depicts a schematic of another exemplary embodiment of a hydraulic system 400 with a branched differential buffer 402 that includes a spring-loaded sliding piston. The branched differential buffer 402 includes a moving piston 404 slidably received in a cylindrical volume 403 in a housing of the differential buffer 402. The differential buffer includes a first spring 408a and a second spring 408b that are interposed between the piston 404 and the housing of the differential buffer 402 on opposing sides of the piston and are arranged to bias the piston in opposite directions along the longitudinal axis of cylindrical volume 403. The first spring 408a and second spring 408b are configured to bias the piston 404 to a neutral position. However, in the embodiment of FIG. 4, the differential buffer 402 is positioned in a hydraulically parallel configuration with the hydraulic device 410 and the hydraulic actuator 412. That is, the differential buffer 402 is located off a flow path between the hydraulic device 410 and the hydraulic actuator 412 in a branched configuration, whereas in the embodiment of FIG. 3 the differential buffer is located along a flow path between a hydraulic device and a hydraulic actuator in a flow-through configuration. In the embodiment of FIG. 4, the differential buffer includes a first port 405a connected to a first flow passage 414 and a second port 405b connected to a second flow passage 416. The first port 405a connects a first internal volume 407a of the differential buffer to the first flow passage 414. Accordingly, the first internal volume 407a is fluidically connected to the hydraulic device 410 and the hydraulic actuator 412. The second port 405b connects a second internal volume 407b of the differential buffer to the second flow passage 416. Accordingly, the second internal volume 407b is fluidically connected to the hydraulic device 410 and the hydraulic actuator 412. It should be noted that the two-port differential buffer 402 is not a flow-through buffer. Consequently, fluid flow between ports 410a and 410b of the hydraulic device 410 and ports 412a and 412b, respectively, of the actuator 412 does not need to pass through the differential buffer and may flow to the actuator directly (e.g., without passing through the differential buffer) via the first flow passage 414 and the second flow passage 416. Of course, while in some cases a direct flow passage may fluidly connect the hydraulic device and actuator, in other embodiments fluid may pass through any type and number of hydraulic components between the hydraulic device and hydraulic actuator including, for example, valves, restrictions, accumulators, and/or any other appropriate hydraulic component as the present disclosure is not so limited. In this configuration, the differential buffer may act on the pressure or flow volume ripple that reaches the first port 405a and the second port 405b of the differential buffer. A differential buffer may include a branched or flow-through configuration, as the present disclosure is not so limited.

As in the embodiment of FIG. 3, the differential buffer 402 of FIG. 4 includes a first internal volume 407a and a second internal volume 407b which are separated by the piston 404. Accordingly, a pressure difference between the first internal volume 407a and the second internal volume 407b is configured to move the piston against the biasing force of the first spring 408a and the second spring 408b. The movement of the piston may mitigate pressure and/or flow fluctuations by, e.g., passive destructive interference.

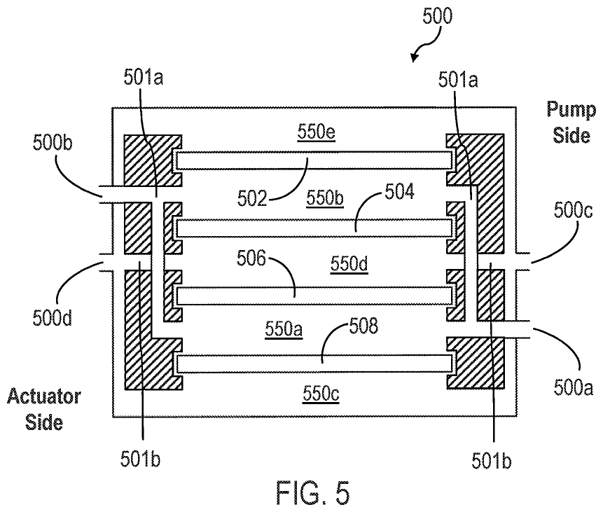

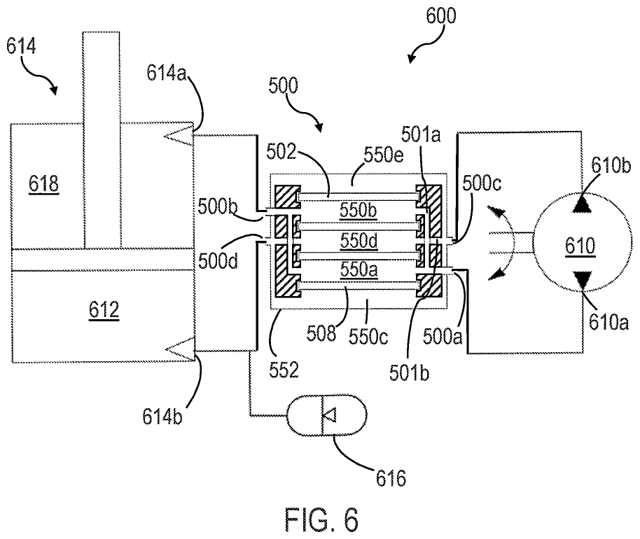

FIG. 5 depicts a schematic of an exemplary embodiment of a differential buffer 500 including a plurality of barriers configured as diaphragms arranged as flexure plates. As shown in FIG. 5, the differential buffer 500 includes a first flexure plate 502, second flexure plate 504, third flexure plate 506, and fourth flexure plate 508. Additionally, the differential buffer of FIG. 5 is configured as a flow-through buffer with a first port 500a, second port 500b, third port 500c, and fourth port 500d. Accordingly, the flexure-plate differential buffer 500 of FIG. 5, may be substituted for the differential buffer 302 of the embodiment illustrated in FIG. 3 in a hydraulic system. Such an exemplary hydraulic system is discussed further with reference to FIG. 6 below.

As shown in FIG. 5, the differential buffer includes a first internal volume 501a and a second internal volume 501b. The first internal volume extends between the first port 500a and the second port 500b. The second internal volume extends between the third port 500c and the fourth port 500d. According to the embodiment of FIG. 5, the first port 500a and third port 500c may be hydraulically connected to ports of a hydraulic device (e.g., a pump). The second port 500b and fourth port 500d may be hydraulically connected to ports of a hydraulic actuator. Of course, in other embodiments the port connections may be reversed, as the present disclosure is not so limited. The first internal volume 501a includes a first chamber 550a and a second chamber 550b. The second internal volume 501b includes a third chamber 550c, a fourth chamber 550d, and a fifth chamber 550e. Each of the chambers are disposed adjacent to at least one of the flexure plates 502, 504, 506, 508. According to the embodiment of FIG. 5, the chambers of the first internal volume and the second internal volume alternate in sequence. That is, the chambers of the first internal volume are adjacent to one or more chambers of the second internal volume on an opposing side of a diaphragm (e.g., a flexure plate) disposed between the two opposing chambers of the first and second internal volumes. Likewise, the chambers of the second internal volume are adjacent to one or more chambers of the first internal volume. However, in some embodiments, there may be no locations in the differential buffer where the same internal volume is disposed on opposing sides of a flexure plate. In this manner, each of the flexure plates, of the exemplary differential buffer shown in FIG. 5, is exposed to a differential pressure between the first internal volume 501a and the second internal volume 501b and deforms or deflects based on that pressure difference. In the specific embodiment of FIG. 5, the first flexure plate 502 is exposed to the pressure in the second chamber 550b and the pressure in the fifth chamber 550e, the second flexure plate 504 is exposed to the pressure in the second chamber 550b and the pressure in the fourth chamber 550d, the third flexure plate 506 is exposed to the pressure in the first chamber 550a and the fourth chamber 550d, and the fourth flexure plate 508 is exposed to the pressure in the first chamber 550a and the pressure in the third chamber 550c. The alternating structure shown in FIG. 5, and/or the number of flexure plates, may be expanded or reduced to achieve a desired form factor for a differential buffer with a desired stiffness, as the present disclosure is not so limited.

According to the embodiment of FIG. 5, the flexure plates 502, 504, 506, 508 may be configured with an appropriate stiffness to allow elastic deformation during normal operation to accommodate an operational pressure differential in a hydraulic circuit as well as pressure fluctuations generated by a hydraulic device. The stiffness may be at least partially determined based on the dimensions of each plate as well as the thickness of each chamber of the first internal volume 501a and the second internal volume 501b. In some embodiments, the relative space between the flexure plates provided by each chamber may determine stiffness of the flexure plates such that the flexure plates do not touch one another or otherwise obstruct the chambers during normal operation of the differential buffer. However, in some other embodiments, some or all plates may be allowed to contact one another at a given pressure differential, as the present disclosure is not so limited. In some embodiments, when two plates contact one another, the compliance of contacting plates may increase substantially. In some such cases, if the pressure differential is too great, adjacent flexure plates may deform enough to contact one another, at which point the flexure plates will have a significantly increased stiffness with which to mitigate differential pressure. Accordingly, the material characteristics of the flexure plates may be selected to provide an appropriate performance for a desired operational pressure differential, as discussed previously.

FIG. 6 depicts a schematic of an exemplary embodiment of a hydraulic system 600 with a differential buffer 500 that includes flexure plates similar to the differential buffer of FIG. 5. In the hydraulic system 600, the first port 500a and third port 500c of the flexure-plate differential buffer 500 are hydraulically connected to a first hydraulic device port 610a and a second hydraulic device port 610b, respectively, of a hydraulic device 610. The second port 500b of the differential buffer 500 is hydraulically connected to an extension volume 618 (e.g., via a first actuator port 614a) of a hydraulic actuator 614, while the fourth port 500d is hydraulically connected to a compression volume 612 of the actuator 614 (e.g., via a second actuator port 614b). According to the embodiment of FIG. 6, the hydraulic system also includes an accumulator 616 (e.g., a gas filled accumulator) hydraulically connected to the fourth port 500d.

In the embodiment of FIG. 6, the pressures in the first chamber 550a and second chamber 550b of the first internal volume 501a may be equivalent to or effectively equivalent to each other. Additionally, the operational pressure of the first internal volume, the pressure in the extension volume 618, and the operational pressure at the first hydraulic device port 610a of the hydraulic device 610 may be equivalent or effectively equivalent to each other. Of course, in some embodiments, these operational pressures may vary from one another due to pressure losses between the hydraulic device 610 and the actuator 614. According to the embodiment of FIG. 6, any pressure difference caused by pressure and/or flow fluctuations may be present at the first hydraulic device port 610a but may be mitigated or canceled in the first internal volume 501a. Accordingly, the pressure and/or flow fluctuations may not be present or may be diminished in the extension volume 618. Likewise, the operational pressures in the third chamber 550c (disposed between the fourth plate 508 and a housing 552), fourth chamber 550d (disposed between the second plate 504 and the third plate 506), and fifth chamber 550e (disposed between the first plate 502 and the housing 552) of the second internal volume 501b are equivalent to or effectively equivalent to each other. Additionally, the pressure of the second internal volume, the pressure in the compression volume 612, and the pressure at the second hydraulic device port 610b of the hydraulic device 610 may be equivalent or effectively equivalent to each other. Of course, in some embodiments, these operational pressures may vary from one another due to pressure losses between the hydraulic device 610 and the actuator 614. According to the embodiment of FIG. 6, any pressure difference caused by pressure and/or flow fluctuations may be present at the second hydraulic device port 610b but may be mitigated or canceled in the second internal volume 501b. Accordingly, the pressure and/or flow fluctuations may not be present or may be diminished in the compression volume 612. As discussed with reference to FIG. 5, the flexure plates may deform (e.g., elastically) to accommodate and mitigate or cancel pressure and/or flow ripple generated by the hydraulic device 610.

According to the embodiment of FIG. 6, the various flow passages on opposing sides of the hydraulic system 600 may have similar (e.g., equivalent) inertances and/or impedances at least between the hydraulic device and the differential buffer. In some embodiments, the inertance and/or impedance of the first internal volume 501a is within 50% of the inertance and/or impedance of the second internal volume 501b, and, in some embodiments, the inertance and/or impedance of the first internal volume 501a is equal to the inertance and/or impedance of the second internal volume 501b. In some embodiments, an inertance and/or impedance of a flow passage between the second port 500b and the first hydraulic actuator port 614a and an inertance and/or impedance of the flow passage between the fourth port 500d and the second hydraulic actuator port 614b are within 50% of one another, and, in some embodiments are equal to one another. In some embodiments, an inertance and/or impedance of a flow passage between the first port 500a and the first hydraulic device port 610a and an inertance and/or impedance of the flow passage between the third port 500c and the second hydraulic device port 610b are within 50% of one another, and, in some embodiments are equal to one another. For example, the first and second flow passages connecting the first hydraulic device port 610a and second hydraulic device port 610b of the hydraulic device 610 to the corresponding first port 500a and third port 500c of the buffer 500 may have matched inertances and/or impedances within a predetermined range of each other (e.g., within 50%), as described above, to provide a desired phase relationship of pressure and/or flow fluctuations propagating to or from the hydraulic device. In some embodiments, an inertance and/or impedance of an entire flow passage between the first hydraulic device port 610a and the second hydraulic actuator port 614b is within 50% of an inertance and/or impedance of an entire flow passage between the second hydraulic device port 610b and first hydraulic actuator port 614a, and, in some embodiments, are equal to one another.

In some modes of operation of a hydraulic system like that of exemplary FIG. 6, the pressure on the side of the hydraulic device where an accumulator is located may remain substantially constant during the operation of the hydraulic device while the pressure on the other side of the hydraulic device may vary significantly. In the exemplary hydraulic system 600 of FIG. 6, the operational pressure of the compression volume 612 and the accumulator 616 may remain substantially constant due to the accumulator 616, while the pressure in the extension volume may vary substantially depending on the operating state of the hydraulic device 610. As a result, in the exemplary hydraulic system 600, the pressures in the first chamber 550a and second chamber 550b may vary significantly, while the pressures in the third chamber 550c, fourth chamber 550d, and fifth chamber 550e may remain relatively constant. In the embodiment of FIG. 6, the chambers of the differential buffer 500 are arranged such that the housing 552 of the differential buffer 500 is exposed to the relatively constant operational pressure of the accumulator 616 and the compression volume 612. As a result, the housing 552 may be shielded from the extremes and fluctuations of the pressure in the hydraulic system. Alternatively, in some embodiments, the location of the accumulator 616 may be changed so that the accumulator is fluidically located on the extension side of the system and the pressure of the extension volume is equivalent to or effectively equivalent to the accumulator pressure. In such an embodiment, to maintain the shielding of the accumulator housing, the flow passages in the hydraulic system may be altered so that pressures in chambers 550c, 550d, and 550e are again equivalent to or effectively equivalent to the relatively constant accumulator pressure. Of course, in other embodiments the chambers of the first internal volume 501a or the second internal volume 501b may be exposed to pressure fluctuations, as the present disclosure is not so limited.

Depending on the amount of deflection of the diaphragms of an exemplary differential buffer, such as the flexure plates 502, 504, 506, and 508 in the differential buffer 500 of FIGS. 5 and 6, equations, nonlinear analysis (e.g., using finite element analysis), and/or other appropriate methods may be used to calculate the volumetric stiffness of the buffer at a given deflection as well as the maximum stress realized in the part. The inventors have also recognized that a significant increase in volumetric stiffness may be achieved at larger deflections depending on the specific geometry of the separating diaphragms. In some embodiments, the desired maximum stiffness may be limited at a 400 psi (e.g., 2.76 MPa) operational pressure differential (e.g., maximum differential pressure when the actuator is being actively driven by the hydraulic device) to less than 2.5 times the stiffness at operational pressure differential at less than 10 psi.

The inventors have recognized that, in selecting a diaphragm thickness for a differential buffer including at least one diaphragm, there may be a trade-off between diaphragm thickness and stiffness nonlinearity, maximum stress, and total overall packaging volume. A thicker diaphragm may deflect less for the same pressure area and pressure differential. A thicker diaphragm may also exhibit lower maximum stress but may require a larger overall packaging volume. A thicker diaphragm will have a larger stressed area, thereby lowering stress and deflection in the diaphragm for a given pressure differential across the diaphragm but will also increase the size of the diaphragm relative to a thinner diaphragm. For example, a plate with a thickness of 1.06 mm that has a circular pressure area (e.g., a deformable area of the plate exposed to pressurized fluid) with 60 mm diameter may deflect a maximum of 1.2 mm at 3.5 MPa. A differential buffer with 10 such plates may achieve a stiffness between 150-250 Pa/mm³ and occupy approximately 100 cc of total volume. A thicker plate of 1.4 mm with the same pressure area may deflect 0.76 mm at 3.5 MPa and with 18 plates achieve the same overall volumetric stiffness target (as the differential buffer with 1.06 mm plates) may require approximately 150 cc of total volume. The thinner plates may have a stiffness nonlinearity of approximately 2× and a max stress of 1600 MPa whereas the thicker plates may have a stiffness nonlinearity of 1.25× and a max stress of 1200 MPa. Expected deflections of these plates are illustrated in the figures described below.

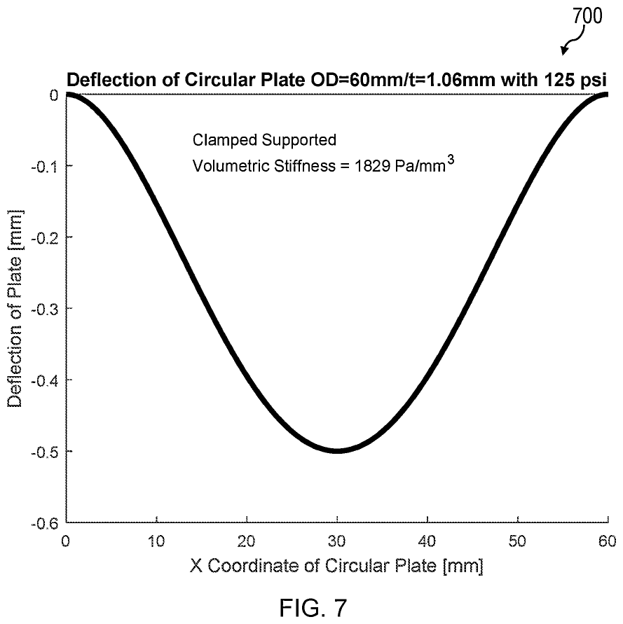

FIG. 7 shows a graph 700 of an estimate of the deflection of a circular plate bending with a clamped or fixed edge constraint with deflection less than half the plate thickness. In particular, without wishing to be bound by theory, FIG. 7 depicts a visualization of Roark's equations for thin plate deflections and show a bending mode and an estimate of volumetric stiffness of the circular plate. Nonlinear simulation (e.g., finite element analysis) may be used to predict stress beyond the deflection limit shown in FIG. 7. The estimate of deflection as shown in FIG. 7 may be employed to estimate appropriate configurations for a circular plate employed in a differential buffer. Of course, in some embodiments, nonlinear simulation may be used to predict stress before and after deflections limits of a diaphragm, as the present disclosure is not so limited.

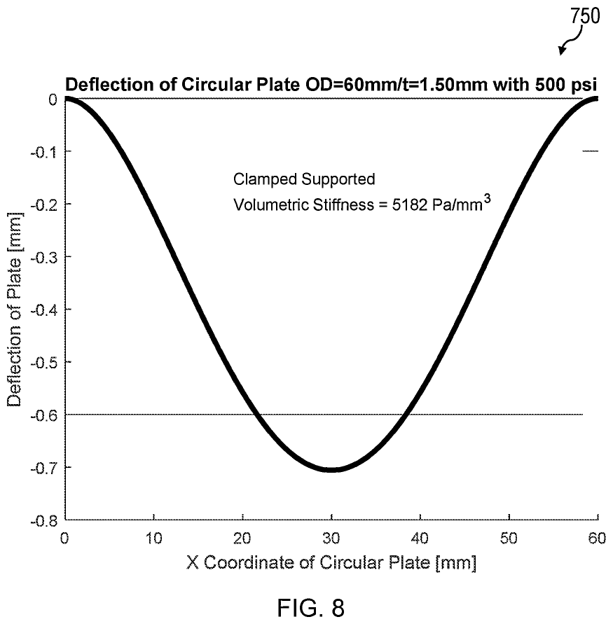

FIG. 8 shows a graph 750 of an estimate of the deflection of a 1.5 mm clamped circular flexure plate at a maximum differential pressure of 500 psi (e.g., 3.45 MPa). In particular, without wishing to be bound by theory, FIG. 8 depicts a visualization of Roark's equations for thin plate deflections and show a bending mode and an estimate of volumetric stiffness of the circular plate. The estimate of deflection as shown in FIG. 8 may be employed to estimate appropriate configurations for a circular plate employed in a differential buffer. The graph of FIG. 8 illustrates the behavior of a clamped or fixed edge constrained with a maximum deflection less than half the plate thickness. This plate may satisfy a maximum pressure design in an elastic regime of the plate. Of course, in some embodiments, nonlinear simulation may be used alternatively or in addition to the solution shown in FIG. 8 to predict stress in a plate based on different plate configurations and bending modes, as the present disclosure is not so limited.

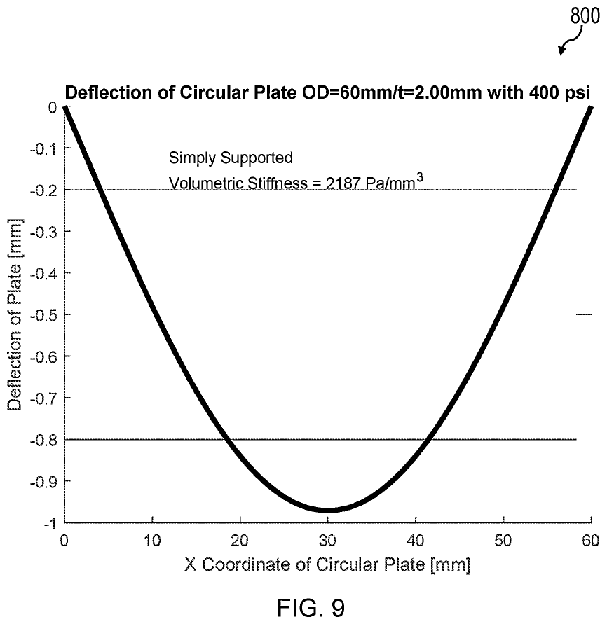

FIG. 9 shows a graph 800 of an estimate of the deflection of a simply supported circular plate (e.g., no moment) with deflection less than half the plate thickness. In particular, without wishing to be bound by theory, FIG. 9 depicts a visualization of Roark's equations for thin plate deflections for a bending mode and an estimate of volumetric stiffness of the circular plate. The estimate of deflection as shown in FIG. 9 may be employed to estimate appropriate configurations for a circular plate employed in a differential buffer. A simply supported constraint system may have 5 times the compliance as a fixed edge constraint. Of course, in some embodiments, nonlinear simulation may be used alternatively or in addition to the solution shown in FIG. 9 to predict stress in a plate based on different plate configurations and bending modes, as the present disclosure is not so limited.

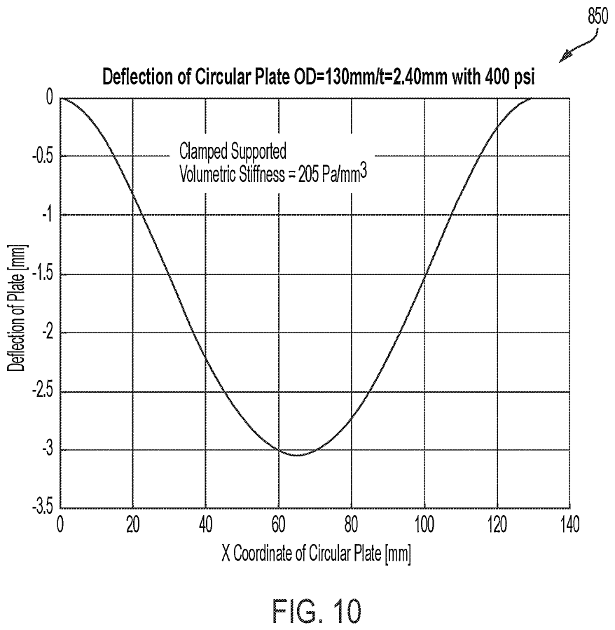

FIG. 10 shows a graph 850 of an estimate of the deflection of a clamped circular plate. In particular, without wishing to be bound by theory, FIG. 10 depicts a visualization of Roark's equations for thin plate deflections for a bending mode and an estimate of volumetric stiffness of the circular plate. The estimate of deflection as shown in FIG. 10 may be employed to estimate appropriate configurations for a circular plate employed in a differential buffer. This embodiment may satisfy a stiffness requirement but with a larger diameter buffer compared to other exemplary arrangements. Of course, in some embodiments, nonlinear simulation may be used alternatively or in addition to the solution shown in FIG. 10 to predict stress in a plate based on different plate configurations and bending modes, as the present disclosure is not so limited.

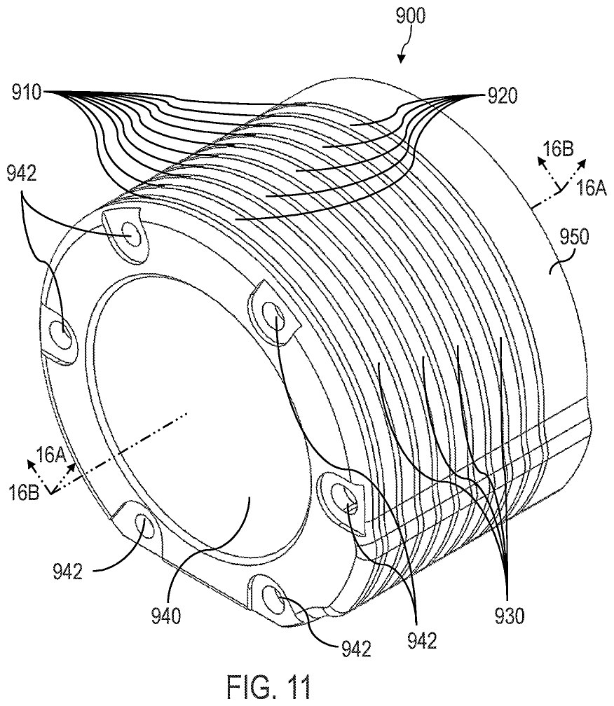

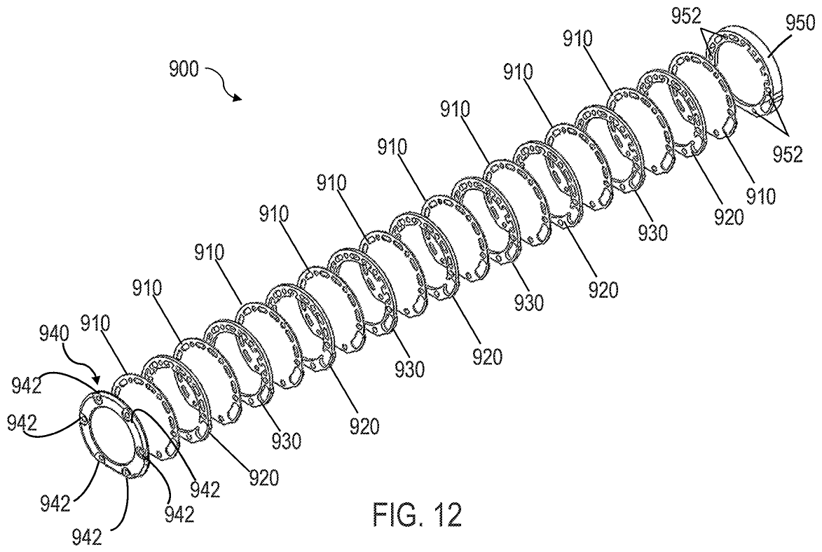

As discussed above, in some embodiments, a differential buffer including a plurality of clamped flexure plates may be configured as a four-port flow-through device. In some embodiments, the clamping region of the plates located radially outwards from the deflectable portions of a diaphragm (e.g., a pressure area) may include cutouts that may be employed for routing one or more flow channels of a differential buffer internal volume including, for example, a first flow channel and a second flow channel. FIG. 11 depicts a perspective view of one embodiment of a differential buffer 900 including a plurality of diaphragms arranged as flexure plates 910. The differential buffer also includes a plurality of spacers 920, 930 configured to secure the flexure plates 910 and also form intervening chambers between adjacent flexure plates. The spacers 920, 930 and flexure plates are employed to form flow channels through the differential buffer. According to the embodiment of FIG. 12, the differential buffer is configured as a flow-through differential buffer, though alternative embodiments are contemplated where the differential buffer has a branched configuration, as the present disclosure is not so limited. As shown in FIG. 11, the differential buffer includes a first end cap 940 and a second end cap 950 which are employed to contain and secure the assembly of flexure plates 910 and spacers 920, 930 together. The first end cap may include a plurality of through holes 942 which align with holes formed in the flexure plates 910, spacers 920, 930, and the second end cap. Accordingly, in some embodiments a suitable fastener (e.g., a bolt, stud and nut, rivet, etc.) may be employed to clamp the differential buffer assembly together. The functionality of the differential buffer 900 is discussed further with reference to FIGS. 12-16B.

FIG. 12 depicts an exploded perspective view of the differential buffer 900 of FIG. 11. The differential buffer of the exemplary embodiment of FIG. 12 includes 10 flexure plates 910. Of course, in other embodiments any appropriate number of flexure plates may be employed, as the present disclosure is not so limited. The differential buffer also includes first spacers 920 and second spacers 930. The first spacers and second spacers both function to separate and secure the intervening flexure plates 910. However, the first spacers and second spacer differ in flow cutouts to provide alternating flow chambers on either side of each flexure plate 910. In the embodiment of FIG. 12, the thickness of spacer rings establishes appropriate volumes for chambers between the flexure plates 910 that allows the plates to deflect without touching one another at a designed operational pressure differential. Flow channels at the periphery of both the flexure plates and the spacers 920, 930 allow for each of the inter-plate chambers to be fluidically connected to the external ports of the differential buffer. The flow channels are shown and described further with reference to FIGS. 12-16B. The differential buffer 900 also includes a first end cap 940 and a second end cap 950 disposed on either end of the stack of flexure plates and spacers. The flexure plates, spacers, and end caps may be clamped together by using bolts or other fasteners that may be fitted through holes 942 in the first end cap 940 and be threaded into corresponding holes 952 formed in the second end cap 950. The spacers and the plates disposed between the spacers may form a metal-to-metal fluid seal due to the clamping force provide by the bolts. Alternatively or in addition, some or all of the plates, spacers, and end caps may be securely attached to each other, or otherwise held together, by any other appropriate attachment methods, such as for example, brazing and/or welding, including electron-beam welding, as the present disclosure is not so limited. The stacked plate construction provided by the embodiment of FIG. 12 allows for simplified manufacturing of a differential buffer, as the individual plates 910 and spacers 920, 930 may be, for example, stamped and/or machined from plate stock and assembled into a final configuration.

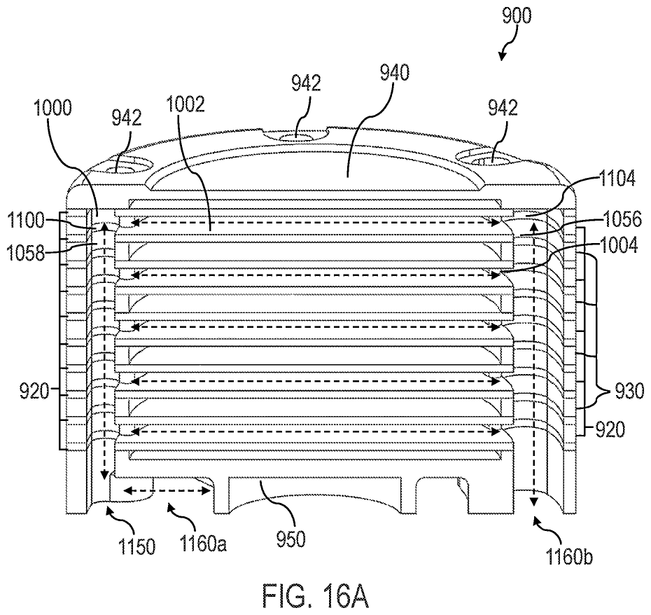

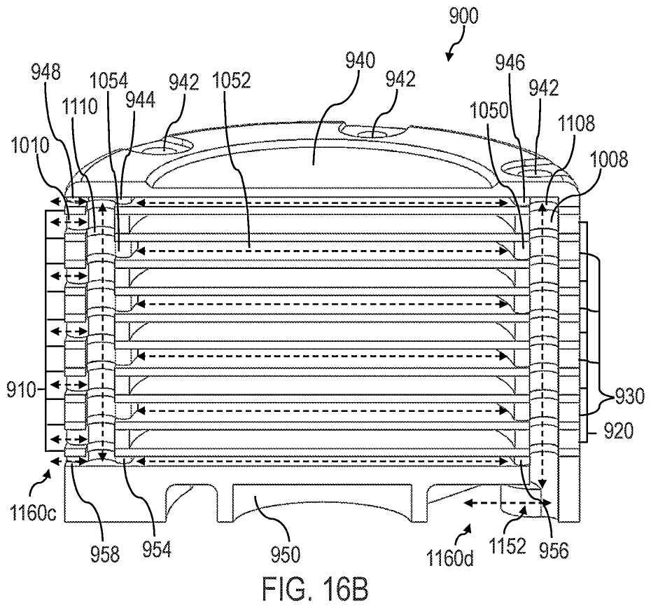

In the embodiment of FIG. 12, two flow channels of two internal volumes may be used to connect the differential buffer 900 to two sides of an associated hydraulic device. These two flow channels may extend through some or all the flexure plates 910, the first spacers 920, and the second spacers 930, thereby directing the flow to the appropriate inter-plate or plate-to-end-cap chambers. The exemplary embodiment of FIG. 12 includes two internal volumes including channels that may be used to route the fluid from a hydraulic device to a hydraulic actuator. As shown in FIG. 12, the first spacers 920 alternate with the second spacers 930 to provide alternating flow chambers associated with two sides of the differential buffer. The flow path of fluid through the differential buffer is discussed further with reference to FIGS. 16A-16B.

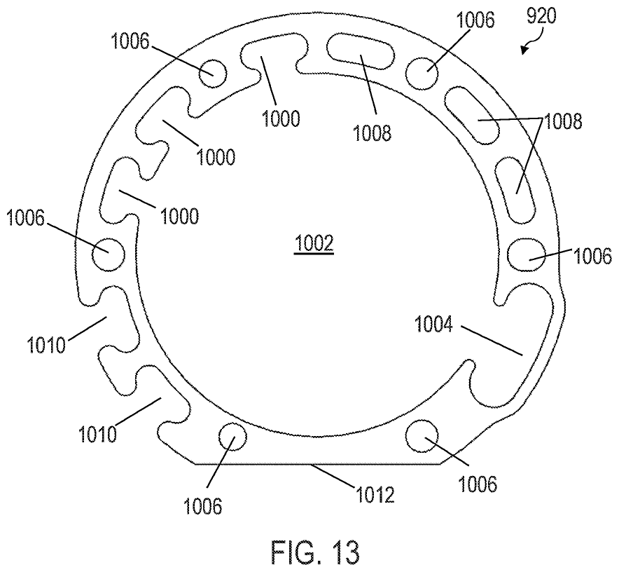

FIG. 13 illustrates a top view of a first spacer 920 of the differential buffer illustrated in FIG. 12. In this drawing, three first flow cutouts 1000 may be used to fluidically connect an inter-plate chamber 1002, defined by the first spacer and two abutting flexure plates (see FIG. 12), to a variable pressure side of a hydraulic device (for example, see second hydraulic device port 610b illustrated in FIG. 6) that undergoes frequent and significant swings in pressure. While openings configured as cutouts 1000 may be employed in some embodiments as shown in FIG. 13, in other embodiments any appropriate opening may be employed that is connected to an inter-plate chamber (e.g., the opening forms a portion of a perimeter of the inter-plate chamber). A second flow cutout 1004 may be used to fluidically connect the inter-plate chamber 1002 to the variable pressure side of a hydraulic actuator (for example, see first actuator port 614a illustrated in FIG. 6). Of course, in other embodiments, the first flow cutouts 1000 and second flow cutout may be configured to connect the inter-plate chamber 1002 to a relatively constant pressure side of a hydraulic device (for example, see first hydraulic port 610a in FIG. 6) and a hydraulic actuator (for example, see second actuator port 614b), as the present disclosure is not so limited. It is noted that the terms “constant pressure” and “variable pressure” used are relative and not absolute terms. The “constant pressure” side of a hydraulic system, such as that shown in FIG. 6, may also undergo measurable swings in pressure. Under typical operating conditions when an actuator is driven by the hydraulic device, the “constant pressure” side of the hydraulic device of such a hydraulic system is a side that is fluidically connected to an accumulator and thus typically experiences significantly smaller swings in pressure than a variable pressure side. The first spacer 920 also includes first through channels 1008 and second through channels 1010 that pass through the spacer 920 but fluidically connect to an opposite side of the differential buffer. For example, if the first flow cutouts 1000 and second flow cutouts 1004 are associated with a first internal volume of a differential buffer, the first through channels 1008 and the second through channels 1010 are associated with a second internal volume of the differential buffer. In some embodiments as shown in FIG. 13, the second through channels 1010 are also fluidically connected to fluid in a housing of the differential buffer 900. The exterior openings in the second through channels 1010 may be used to surround the differential buffer with pressure from an accumulator side of a hydraulic system to protect the buffer housing from the more dynamic variable pressure fluctuations with higher peak pressures. While the embodiment of FIG. 13 includes specific numbers and/or shapes of openings (e.g., cutouts) and channels, any suitable number of channels or openings of appropriate shape and size may be employed to provide a first internal volume and a second internal volume in a differential buffer, as the present disclosure is not so limited.

As shown in FIG. 13, the first spacer 920 also includes through holes 1006 that allow clamping bolts or other fasteners to pass through the first spacer 920. The through holes 1006 may align with holes formed in flexure plates, second spacers, and first and second end caps such that the differential buffer may be easily stacked, assembled, and secured.

According to the embodiment of FIG. 13, the first spacer 920 is approximately annular and shaped as a ring. The first spacer is configured to support a flexure plate formed in an at least partially circular disk. Of course, in other embodiments, a spacer may have any suitable shape, as the present disclosure is not so limited. In some cases, during assembly it may be difficult to align the cutouts and holes in a stack of plates. Accordingly, in some embodiments as shown in FIG. 13, the first spacer may include an indexing feature such as, for example, flat 1012 which may be used to align the first spacer with flexure plates, other first spacers, second spacers, and/or end caps of a differential buffer. In some embodiments, a differential buffer may be aligned by placing an indexing flat of multiple components of the differential buffer on a flat surface. Of course, while a flat is employed in the embodiment of FIG. 13, any suitable shape, recess, or projection or feature may be employed to align a plurality of spacers and plates in a differential buffer, as the present disclosure is not so limited.

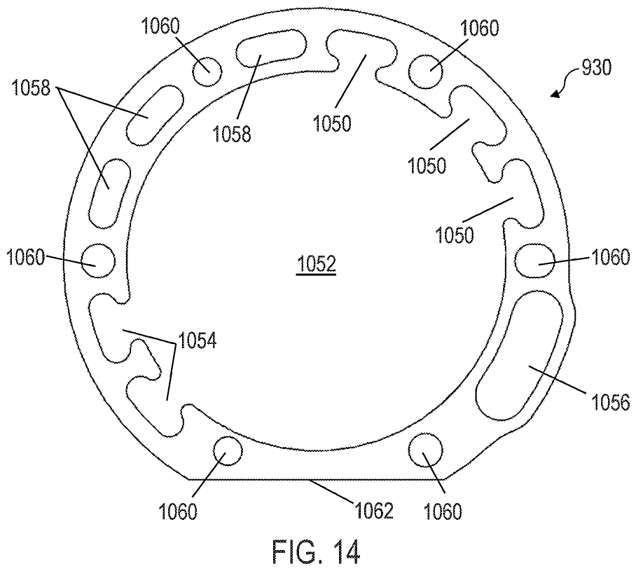

FIG. 14 illustrates a top view of a second spacer 930 of the differential buffer illustrated in FIG. 12. In this drawing, three third flow cutouts 1050 may be used to fluidically connect an inter-plate chamber 1052, defined by the second spacer and two abutting flexure plates (see FIG. 12), to a constant pressure side (e.g., accumulator side) of a hydraulic device (for example, see first hydraulic device port 610a illustrated in FIG. 6) that does not undergo frequent and significant swings in pressure. While openings configured as cutouts 1050 may be employed in some embodiments as shown in FIG. 14, in other embodiments any appropriate opening may be employed that is connected to the inter-plate chamber 1052 (e.g., the opening forms a portion of a perimeter of the inter-plate chamber). Fourth flow cutouts 1054 may be used to fluidically connect the inter-plate chamber 1052 to the constant pressure side of a hydraulic actuator (for example, see second actuator port 614b illustrated in FIG. 6). Of course, in other embodiments, the third flow cutouts 1050 and fourth flow cutouts 1054 may be configured to connect the inter-plate chamber 1052 to a variable pressure side of a hydraulic device (for example, see second hydraulic port 610b in FIG. 6) and a hydraulic actuator (for example, see first actuator port 614a), as the present disclosure is not so limited. The terms “constant pressure” and variable pressure used are relative and not absolute terms, as discussed above with reference to FIG. 13. The second spacer 930 also includes third through channels 1058 and second through channels 1056 that pass through the second spacer 930 but fluidically connect to an opposite side of the differential buffer. For example, if the third flow cutouts 1050 and fourth flow cutouts 1054 are associated with a second internal volume of a differential buffer, the third through channels 1058 and the fourth through channel 1056 are associated with a first internal volume of the differential buffer. While the embodiment of FIG. 14 includes specific numbers, shapes, and sizes of openings and channels, any appropriate number, shape, and size of channels may be employed to provide a first internal volume and a second internal volume in a differential buffer, as the present disclosure is not so limited.

As shown in FIG. 14, the second spacer 930 also includes through holes 1060 that allow clamping bolts or other fasteners to pass through the second spacer. The through holes 1060 may align with holes formed in flexure plates, first spacers, other second spacers, and first and second end caps such that the differential buffer may be easily stacked and assembled.

According to the embodiment of FIG. 14, the second spacer 930 is annular and shaped as a ring. The second spacer is configured to support a flexure plate formed in an at least partially circular disk. Of course, in other embodiments, the second spacer may have any suitable shape, as the present disclosure is not so limited. In some cases, during assembly it may be difficult to align a stack of circular plates. Accordingly, in some embodiments as shown in FIG. 14, the second spacer may include an indexing flat 1062 which may be used to align the second spacer with flexure plates, first spacers, other second spacers, and/or end caps of a differential buffer, as discussed with reference to FIG. 13.

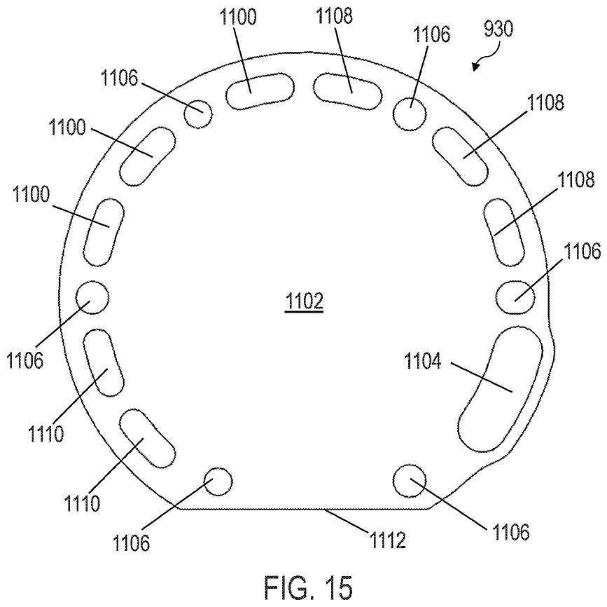

FIG. 15 shows the top view of the flexure plate 910 illustrated in FIG. 12. As shown in FIG. 15, the flexure plate includes a plurality of openings (e.g., cutouts) arranged around a periphery of the flexure plate which provide fluid passage and interconnect the openings and channels described with reference to FIGS. 13 and 14. In particular, the flexure plate includes first flow cutouts 1100 configured to connect first flow openings of a first spacer to third through channels of a second spacer. The flexure plate also includes a second flow cutout 1104 configured to connect a second flow cutout of a first spacer to a fourth through channel of a second spacer. The flexure plate also includes third flow holes 1108 configured to connect first through channels of a first spacer to third flow cutouts of a second spacer. The flexure plate also includes fourth flow holes 1110 configured to connect second through channels of a first spacer to fourth flow cutouts of a second spacer. In this manner, the flexure plate provides fluid interconnections between the first spacers and second spacers.

As shown in FIG. 15, the flexure plate 910 also includes through holes 1106 that allow clamping bolts or other fasteners to pass through the flexure plate. The through holes 1106 may align with holes formed in other flexure plates, first spacers, second spacers, and first and second end caps such that the differential buffer may be easily stacked and assembled.

According to the embodiment of FIG. 15, the flexure plate 910 is shaped as a disk. The flexure plate is configured to be supported by the annular spacers of FIGS. 13 and 14. a central portion 1102 of the flexure plate is configured to deform, flex, or deflect in response to a pressure differential across the flexure plate in different inter-plate flow chambers. Of course, in other embodiments, the flexure plate may have any suitable shape, with or without cutouts, as the present disclosure is not so limited. In some cases, during assembly it may be difficult to align a stack of circular plates. Accordingly, in some embodiments as shown in FIG. 15, the flexure plate may include an indexing flat 1112 which may be used to align the flexure plate with other flexure plates, first spacers, second spacers, and/or end caps of a differential buffer, as discussed with reference to FIGS. 13-14.

FIG. 16A depicts a first cross-section of the differential buffer 900 of FIG. 11 taken along line 16A-16A depicting a first internal volume 1150 of the differential buffer. As shown in FIG. 16A, the stacked flexure plates 910, first spacers 920, and second spacers 930 forms the first internal volume including a plurality of inter-plate chambers disposed between the flexure plates. As shown in FIG. 16A, the inter-plate chambers alternate with inter-plate chambers connected to a second internal volume (see FIG. 16B). As shown in FIG. 16A, the flexure plates include first flow cutouts 1100 connecting first flow cutouts 1000 of the first spacers 920 to third through channels 1058 of the second spacers 930. The flexure plates also include a second flow cutout 1104 connecting a second flow cutout 1004 of the first spacers to a fourth through channel 1056 of the second spacers. Accordingly, the first internal volume 1150 is formed by the stacked flexure plates, first spacers, and second spacers. As shown in FIG. 16A, the first internal volume passing through the deferential buffer terminates in a first port 1160a and a second port 1160b which may be hydraulically connected to a port of a hydraulic device and hydraulic actuator, respectively. According to the embodiment of FIG. 16A, the first port and second port are disposed on the second end cap 950. Of course, any suitable location of the first port and second port may be employed, as the present disclosure is not so limited.

FIG. 16B depicts a second cross section of the differential buffer 900 of FIG. 11 taken along line 16B-16B depicting a second internal volume 1152 of the differential buffer. As shown in FIG. 16B, the stacked flexure plates 910, first spacers 920, and second spacers 930 forms the second internal volume including a plurality of inter-plate chambers disposed between the flexure plates. As shown in FIG. 16B, the inter-plate chambers alternate with inter-plate chambers connected to a first internal volume (see FIG. 16A). As shown in FIG. 16B, the flexure plates include third flow holes 1108 connecting first through channels 1008 of the first spacers to third flow cutouts 1050 of the second spacers. The flexure plates also include fourth flow holes 1110 connecting second through channels 1010 of the first spacers to fourth flow cutouts 1054 of the second spacers. Additionally, fluid flowing into the cutouts 1050 of the second spacer 930 through the inter-plate chamber 1052 then flows through the second through channels 1010 in the first spacer 920 into an outer housing of the differential buffer. As shown in FIG. 16B, the first end cap 940 includes a first end cap opening 944 and a second end cap opening 946 which also connect to the second internal volume and provide a fluid chamber between an end flexure plate and the first end cap. Likewise, the second end cap 950 includes a third end cap opening 954 and a fourth end cap opening 956 which also connect to the second internal volume and provide a fluid chamber between an end flexure plate and the second end cap. Accordingly, the second internal volume 1152 is formed by the stacked flexure plates, first spacers, second spacers, first end cap 940, and second end cap 950. As shown in FIG. 16B, the second internal volume 1152 passing through the deferential buffer terminates in a third port 1160c and a fourth port 1160d which may be hydraulically connected to a port of a hydraulic device and hydraulic actuator, respectively.

As shown in FIG. 16B, the first spacers 920 include second through channels 1010 that open to a housing of the differential buffer. Likewise, the first end cap includes a first housing opening 948 and the second end cap 950 includes a second housing opening 958 that open to the outer housing of the differential buffer. The second through channels 1010, first housing opening 948, and second housing opening 958 are employed used to surround the differential buffer (e.g., inside of the outer housing) with pressure from an accumulator side of a hydraulic system to protect the buffer housing from the more dynamic variable pressure fluctuations with higher peak pressures. Of course, in other embodiments the differential buffer may not include a surrounding fluid pressure chamber, as the present disclosure is not so limited.

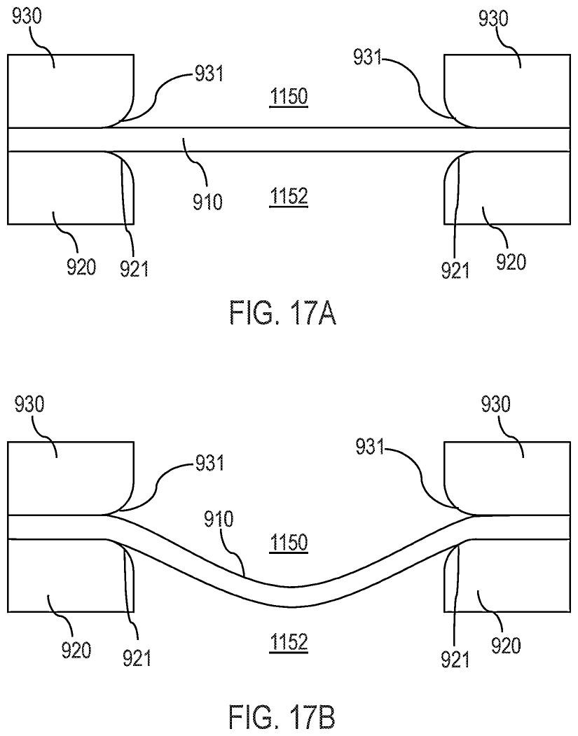

FIG. 17A depicts a side schematic of one embodiment of a diaphragm configured as a flexure plate 910, a first spacer 920, and second spacer 930 in a first state. In some embodiments the schematic shown in FIG. 17A may be representative of an engagement between a spacer and a flexure plate of the embodiment of FIGS. 11-16B. As shown in FIG. 17A, the flexure plate 910 is abutting the first spacer 920 and the second spacer 930. The flexure plate 910 separates a first internal volume 1150 and a second internal volume 1152, and the flexure plate is configured to deform based on a pressure difference between the first internal volume and the second internal volume. The first and second spacers engage the flexure plate and form a seal between the spacer and the flexure plate, as discussed previously. According to the embodiment of FIG. 17A, the spacer 920 may include a curved edge 921 that forms an inner boundary of the spacer 920. The curved edge is configured to curve away from the flexure plate, such that the curved edge provides space for the flexure plate to deform toward the first spacer (e.g., into an opening defined by the curved edge 921). The curved edge allows the flexure plate to deform while avoiding and/or reducing stress risers in the spacer and/or flexure plate that would be associated with a sharp boundary of the first spacer. Like the first spacer, the second spacer 930 may include a curved edge 931 that forms an inner boundary of the second spacer. The curved edge 931 allows the flexure plate 910 to deform toward the second spacer while avoiding and/or reducing stress risers in the spacer and/or flexure plate that would be associated with a sharp boundary of the second spacer.

FIG. 17B depicts the diaphragm (e.g., flexure plate 910) and spacers 920, 930 of FIG. 17A in a second state. As shown in FIG. 17B, the flexure plate as deformed based on a pressure differential between the first internal volume 1150 and the second internal volume 1152. In particular, the pressure of the first internal volume 1150 is greater than the pressure of the second internal volume, causing the flexure plate to elastically deform away from the first internal volume. Accordingly, the flexure plate has deformed into an opening of the first spacer 920 defined by the curved edge 921. As shown in FIG. 17B, the curved edge allows the flexure plate 910 to transition from a portion of the flexure plate held at zero slope relative to a housing of the differential buffer by the first spacer and second spacer to a portion of the of the flexure plate having a non-zero slope. In some embodiments, zero slope may be defined as being parallel to a plane of the flexure plate in an undeformed state where a substantially zero pressure differential is applied across the flexure plate or other diaphragm. The curved edge 921 may provide support for the flexure plate to avoid stress risers that may be associated with a sharp (e.g., square edge). When the flexure plate deforms in an opposite direction (e.g., when the pressure of the second internal volume 1152 is greater than the pressure of the first internal volume 1150), the curved edge of the second spacer 930 may function similarly and avoid or reduce stress concentration in the flexure plate. Of course, in other embodiments, any suitable shape of edge for a spacer may be employed, as the present disclosure is not so limited.

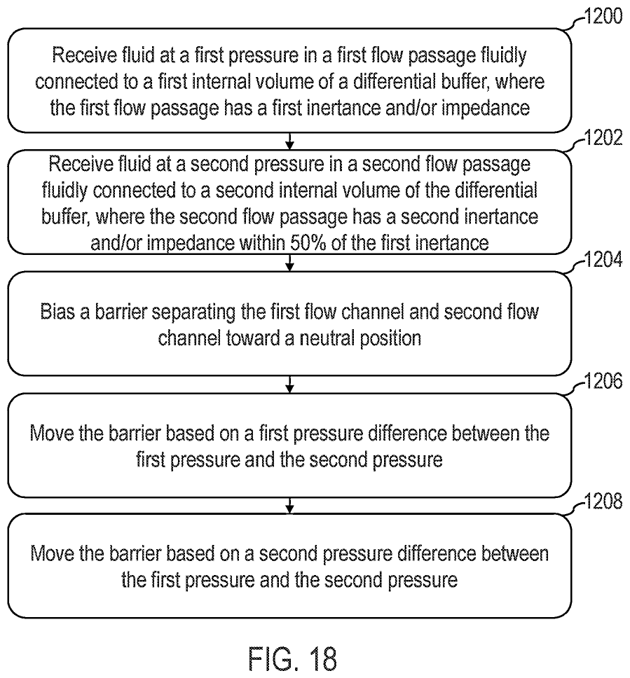

FIG. 18 is a flow chart for one embodiment of a method of operating a hydraulic circuit. In block 1200, fluid is received at a first pressure in a first flow passage fluidly connected to a first internal volume of a differential buffer, where the first flow passage has a first inertance and/or impedance. In block 1202, fluid is received at a second pressure in a second flow passage fluidly connected to a second internal volume of the differential buffer, where the second flow passage has a second inertance and/or impedance within 50% of the first inertance and/or impedance. In some embodiments, the first inertance and/or impedance may be substantially or effectively equal to the second inertance and/or impedance. In some embodiments, the first inertance and/or impedance may include additional flow passages extending between the differential buffer and a hydraulic device (e.g., a pump) in a hydraulic circuit. Likewise, the second inertance and/or impedance may include additional flow passages extending between the differential buffer and a hydraulic device (e.g., a pump) in a hydraulic circuit. According to such embodiments, the first inertance and/or impedance of a first hydraulic device flow passage of a hydraulic circuit including the first internal volume may be within 50% of or equal to the second inertance and/or impedance of a second hydraulic device flow passage of a hydraulic circuit including the second flow passage. In block 1204, a barrier separating the first internal volume and second internal volume may be biased toward a neutral position. In block 1206, the barrier is moved based on a first pressure difference between the first pressure and the second pressure. In some embodiments, moving the barrier may include moving at least one piston in at least one cylinder based on the pressure difference. In some embodiments, moving the barrier may include deforming (e.g., elastically) at least one diaphragm. In some embodiments, the first pressure difference may be an operational pressure difference for a hydraulic circuit. That is, the first pressure difference may not include pressure fluctuations. In block 1208, the barrier is moved based on a second pressure difference between the first pressure and second pressure. The second pressure difference may be a pressure difference caused by pressure fluctuations. The movement of the barrier based on the second pressure difference may cancel or otherwise mitigate the pressure fluctuations in the first internal volume and the second internal volume.

It should be noted that while the flow chart of exemplary FIG. 18 depicts an order to the exemplary method, in some embodiments the steps in blocks 1200, 1202, 1204, 1206, and 1208 may occur in any order or substantially simultaneously, as the present disclosure is not so limited. For example, in some embodiments, fluid may be received in the first flow passage and the second flow passage simultaneously. As another example, in some embodiments, fluid flow and movement of the barrier may occur effectively simultaneously due to the incompressible nature of the fluid flow. Likewise, in some embodiments flow and/or pressure fluctuations associated with the second pressure difference may occur effectively simultaneously with fluid flow and movement of the barrier.

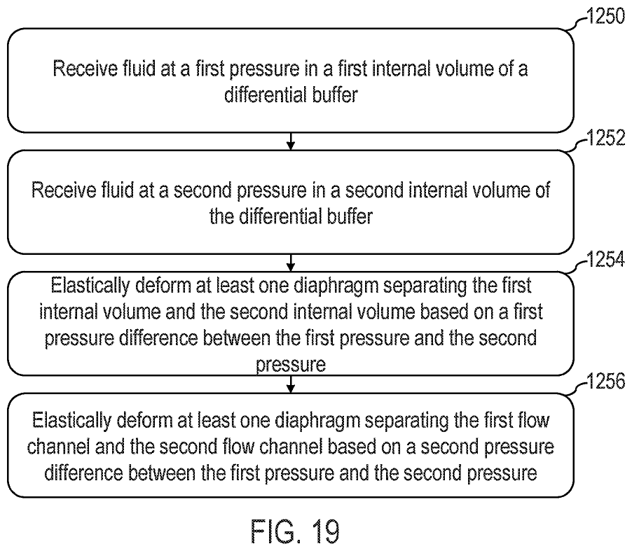

FIG. 19 is a flow chart for another embodiment of a method of operating a hydraulic circuit. In block 1250, fluid is received at a first pressure in a first internal volume of a differential buffer. In block 1252, fluid is received at a second pressure in a second internal volume of the differential buffer. In block 1254, at least one diaphragm separating the first internal volume and the second internal volume is elastically deformed based on a first pressure difference between the first pressure and the second pressure. In some embodiments, the at least one diaphragm may be a plurality of diaphragms. In some embodiments, the plurality of diaphragms may be between 6 and 12 diaphragms. In some embodiments, the first pressure difference may be an operational pressure difference for a hydraulic circuit. That is, the first pressure difference may not include pressure fluctuations. In block 1256, the at least one diaphragm is elastically deformed based on a second pressure difference between the first pressure and second pressure. The second pressure difference may be a pressure difference caused by pressure fluctuations. The deformation of the at least one diaphragm based on the second pressure difference may mitigate the pressure fluctuations in the first internal volume and the second internal volume.

It should be noted that while the flow chart of exemplary FIG. 19 depicts an order to the exemplary method, in some embodiments the steps in blocks 1250, 1252, 1254, and 1256 may occur in any order or simultaneously, as the present disclosure is not so limited. For example, in some embodiments, fluid may be received in the first internal volume and the second internal volume simultaneously. As another example, in some embodiments, fluid flow and deformation of the at least one diaphragm may occur effectively simultaneously due to the incompressible nature of the fluid flow. Likewise, in some embodiments flow and/or pressure fluctuations associated with the second pressure difference may occur effectively simultaneously with the fluid flow and deformation of the at least one diaphragm.

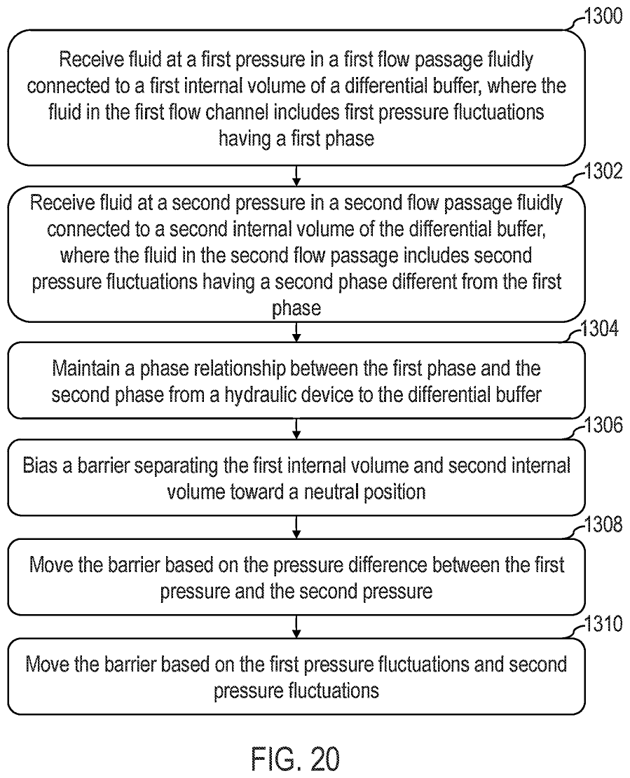

FIG. 20 is a flow chart for one embodiment of a method of operating a hydraulic circuit. In block 1300, fluid is received at a first pressure in a first flow passage fluidly connected to a first internal volume of a differential buffer, where the fluid in the first flow channel includes pressure fluctuations having a first phase. In block 1302, fluid is received at a second pressure in a second flow passage fluidly connected to a second internal volume of the differential buffer, where fluid in the second flow passage includes pressure fluctuations having a second phase different from the first phase. In some embodiments, the pressure fluctuations may be generated by a hydraulic device (e.g., a pump). In some embodiments, the first phase and second phase are inverse relative to one another. For example, the phase of the second pressure fluctuations may be shifted by approximately 180 degrees, or other appropriate relative phase relationship described herein, relative to the first phase. This stated phase relationship is intended to include the addition of any multiples of 360 degrees to the noted phase relationship. In block 1304, a phase relationship between the first phase and the second phase is maintained between a hydraulic device to the differential buffer. For example, in some embodiments, an inertance and/or impedance of the first flow passage and the second flow passage may be within 50% of one another, as discussed with reference to the exemplary embodiment of FIG. 18. According to this example, the phase difference may be maintained. In other embodiments, a phase difference between the first phase and second phase may be changed, but the phase relationship between the first phase and second phase may be substantially maintained. For example, the first phase and/or second phase may shift in any multiple of 360 degrees while maintaining a phase relationship between the first phase and second phase.

According to the embodiment of FIG. 20, in block 1306, a barrier separating the first internal volume and second internal volume may be biased toward a neutral position. In block 1308, the barrier is moved based on the pressure difference between the first pressure and the second pressure. In some embodiments, moving the barrier may include moving at least one piston in at least one cylinder based on the pressure difference. In some embodiments, moving the barrier may include deforming (e.g., elastically) at least one diaphragm. In some embodiments, the first pressure difference may be an operational pressure difference for a hydraulic circuit. In block 1310, the barrier is moved based on the first pressure fluctuations and second pressure fluctuations. The movement of the barrier based on the first pressure fluctuations and second pressure fluctuations may cancel or otherwise mitigate the first and second pressure fluctuations in the first internal volume and the second internal volume due to the phase relationship between the first phase and the second phase.

It should be noted that while the flow chart of exemplary FIG. 20 depicts an order to the exemplary method, in some embodiments the steps in blocks 1300, 1302, 1304, 1306, 1308, and 1310 may occur in any order or simultaneously, as the present disclosure is not so limited. For example, in some embodiments, fluid may be received in the first flow passage and the second flow passage simultaneously. As another example, in some embodiments, fluid flow and movement of the barrier may occur effectively simultaneously due to the incompressible nature of the fluid flow. Likewise, in some embodiments flow and/or pressure fluctuations associated with the second pressure difference may occur effectively simultaneously with fluid flow and movement of the barrier.

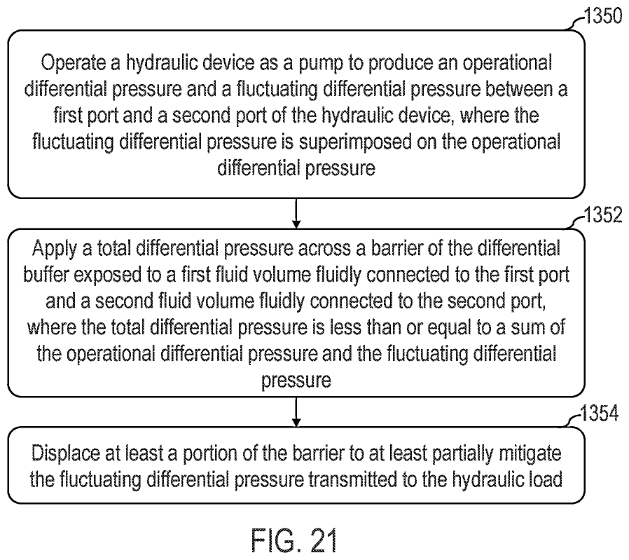

FIG. 21 is a flow chart for one embodiment of a method of operating a hydraulic circuit. In block 1350, a hydraulic device is operated as a pump to produce an operational differential pressure and a fluctuating differential pressure between a first port and a second port of the hydraulic device, where the fluctuating differential pressure is superimposed on the operational differential pressure. The fluctuating differential pressure is less than the operational differential pressure, and the combination of the fluctuating differential pressure and the operational differential pressure may contribute toward a total differential pressure. In block 1352, a total differential pressure is applied across a barrier of the differential buffer exposed to a first fluid volume fluidly connected to the first port and a second fluid volume fluidly connected to the second port. According to the embodiment of FIG. 21, the total differential pressure is less than or equal to a sum of the operational differential pressure and the fluctuating differential pressure. The total differential pressure may be a combined pressure wave at the differential buffer produced by the combination of the fluctuating differential pressure and the operational differential pressure. The total differential pressure may be different than the addition of the fluctuating differential pressure and the operational differential pressure due to interference of the fluctuating differential pressure at the differential buffer. In block 1354, at least a portion of the barrier is displaced to at least partially mitigate the fluctuating differential pressure transmitted to the hydraulic load. Accordingly, the differential buffer may attenuate the fluctuating pressure differential prior to the fluctuating pressure differential reaching any hydraulic load (e.g., a hydraulic actuator). In some embodiments, flow from the first port of the hydraulic device flowing toward a first volume of a hydraulic load (e.g., a hydraulic actuator) is exposed to a first side of the barrier. Likewise, flow from the second port of the hydraulic device flowing toward a second volume of a hydraulic load (e.g., a hydraulic actuator) is exposed to a second side of the barrier. Fluctuations in the flow from the first port and second port that have an at least partially inverse phase may cause volume changes between the first side and second side of the hydraulic system, which is accommodated by the displacement of the barrier as described according to exemplary embodiments herein. In this manner, pressure fluctuations associated with the flow fluctuations are attenuated prior to being transmitted to the hydraulic load via the first volume or second volume.

It should be noted that while the flow chart of exemplary FIG. 21 depicts an order to the exemplary method, in some embodiments the steps in blocks 1350, 1352, and 1354 may occur in any order or simultaneously, as the present disclosure is not so limited. For example, in some embodiments, the operation of the hydraulic device, application of the total differential pressure, and displacement of at least a portion of the barrier may occur effectively simultaneously (e.g., simultaneously).

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A method of operating a hydraulic system that includes a hydraulic device, a hydraulic load, and a differential buffer, the method comprising:
operating the hydraulic device as a pump to produce an operational differential pressure and a fluctuating differential pressure between a first port and a second port of the hydraulic device, wherein the fluctuating differential pressure is superimposed on the operational differential pressure;
applying a total differential pressure across a barrier of the differential buffer exposed to a first fluid volume fluidly connected to the first port and a second fluid volume fluidly connected to the second port, wherein the total differential pressure is less than or equal to a sum of the operational differential pressure and the fluctuating differential pressure; and
displacing at least a portion of the barrier to at least partially mitigate the fluctuating differential pressure transmitted to the hydraulic load.

2. The method of claim 1, wherein the barrier is a diaphragm.

3. The method of claim 2, wherein the diaphragm is edged clamped and displacing at least a portion of the diaphragm includes deforming at least a portion of the diaphragm.

4. The method of claim 1, wherein the hydraulic load is a hydraulic actuator.

5. The method of claim 1, wherein the hydraulic system is an active suspension system.

6. A differential buffer for a hydraulic system comprising:
a first internal volume;
a second internal volume;
a first flow passage fluidly connected to the first internal volume, wherein the first flow passage is configured to fluidly connect to a hydraulic device;
a second flow passage fluidly connected to the second internal volume, wherein the second flow passage is configured to fluidly connect to the hydraulic device, wherein the first flow passage and the second flow passage are configured to maintain a phase relationship of pressure fluctuations in the first flow passage and the second flow passage; and
a barrier separating at least a portion of the first internal volume and at least a portion of the second internal volume, wherein the barrier is configured to move based on a pressure difference between the first internal volume and the second internal volume, and wherein the barrier is biased toward a neutral position.

7. The differential buffer of claim 6, wherein the first flow passage has a first inertance, and wherein the second flow passage has a second inertance within 50% of the first inertance.

8. The differential buffer of claim 7, wherein the first inertance is substantially equal to the second inertance.

9. The differential buffer of claim 6, further comprising at least one spring, wherein the barrier is a piston, and wherein the at least one spring is configured to bias the piston toward the neutral position.

10. The differential buffer of claim 6, wherein the barrier includes at least one diaphragm configured to elastically deformed based on the pressure difference.

11. The differential buffer of claim 10, wherein the at least one diaphragm includes a plurality of diaphragms.

12. The differential buffer of claim 6, wherein the barrier includes a first pressure area exposed to fluid in the first internal volume and a second pressure area exposed to fluid in the second internal volume, wherein the first pressure area is within 50% of the second pressure area.

13. The differential buffer of claim 12, wherein the first pressure area is substantially equal to the second pressure area.

14. The differential buffer of claim 6, wherein the barrier is configured to mitigate pressure fluctuations in the first internal volume and the second internal volume by passive destructive interference.

15. The differential buffer of claim 14, wherein the pressure fluctuations have a pressure between 0.01 and 50 psi.

16. The differential buffer of claim 14, wherein the pressure fluctuations have a frequency between 0 and 2000 Hz.

17. The differential buffer of claim 6, wherein the phase relationship is a phase difference of the pressure fluctuations in the first flow passage and the second flow passage between about 90° and 270°.

18-29. (canceled)

30. A differential buffer for a hydraulic system comprising:
a first internal volume;
a second internal volume;
a first flow passage fluidly connected to the first internal volume, wherein the first flow passage has a first inertance;
a second flow passage fluidly connected to the second internal volume, wherein the second flow passage has a second inertance within 50% of the first inertance; and
a barrier separating at least a portion of the first internal volume and at least a portion of the second internal volume, wherein the barrier is configured to move based on a pressure difference between the first internal volume and the second internal volume, and wherein the barrier is biased toward a neutral position.

31. The differential buffer of claim 30, further comprising at least one spring, wherein the barrier is a piston, and wherein the at least one spring is configured to bias the piston toward the neutral position.

32. The differential buffer of claim 30, wherein the barrier includes at least one diaphragm configured to elastically deformed based on the pressure difference.

33. The differential buffer of claim 32, wherein the at least one diaphragm includes a plurality of diaphragms.

34. The differential buffer of claim 30, wherein the first inertance is substantially equal to the second inertance.

35. The differential buffer of claim 30, wherein the first inertance is within 10% of the second inertance.

36. The differential buffer of claim 30, wherein the barrier includes a first pressure area exposed to fluid in the first internal volume and a second pressure area exposed to fluid in the second internal volume wherein the first pressure area is within 50% of the second pressure area.

37. The differential buffer of claim 36, wherein the first pressure area is substantially equal to the second pressure area.

38. The differential buffer of claim 30, wherein the barrier is configured to mitigate pressure fluctuations in the first internal volume and the second internal volume by passive destructive interference.

39. The differential buffer of claim 38, wherein the pressure fluctuations have a pressure between 0.01 and 50 psi.

40. The differential buffer of claim 38, wherein the pressure fluctuations have a frequency between 0 and 2000 Hz.

41-89. (canceled)
